(19) United States
(12) Patent Application Publication
(10) Pub. No.: US 2025/0086594 A1
(43) Pub. Date: Mar. 13, 2025

(54) METHODS AND SYSTEMS FOR CLASSIFYING RESOURCES TO NICHE MODELS

(71) Applicant: Stynt Inc., Boston, MA (US)

(72) Inventor: Alireza Adeli-Nadjafi, Boston, MA (US)

(73) Assignee: Stynt Inc., Boston, MA (US)

(21) Appl. No.: 18/897,444

(22) Filed: Sep. 26, 2024

Related U.S. Application Data
(63) Continuation-in-part of application No. 17/960,996, filed on Oct. 6, 2022.
Application No. 17/960,996 is a continuation-in-part of application No. 17/335,135, filed on Jun. 1, 2021, now Pat. No. 11,544,626.

(51) Int. Cl. G06Q 10/1053; G06N 20/00

(52) U.S. Cl. CPC G06Q 10/1053; G06N 20/00

(57) ABSTRACT

A system for classifying resources to niche models includes a computing device configured to receive a plurality of resource data corresponding to a plurality of resources, generate a plurality of resource models, generating a resource model corresponding to the resource as a function of the plurality of resource data and the merit quantitative field, compute a niche model having a plurality of niche data and an output quantitative field, combine the niche model with at least a selected resource model corresponding to a selected resource of the plurality of resources by classifying the output quantitative field to at least a selected merit quantitative field of the resource model and a niche datum of the plurality of niche data to at least a datum of the plurality of resource data, and provide an indication of the at least a selected resource model to a client device of the niche model.

### CROSS-REFERENCE TO RELATED APPLICATIONS

This application is a continuation-in-part of Non-provisional application Ser. No. 17/960,996 filed on Oct. 6, 2022, and entitled “METHODS AND SYSTEMS FOR CLASSIFYING RESOURCES TO NICHE MODELS,” which is a continuation-in-part of Non-provisional application Ser. No. 17/335,135 filed on Jun. 1, 2021, now U.S. Pat. No. 11,544,626, issued on Jan. 3, 2023, and entitled “METHODS AND SYSTEMS FOR CLASSIFYING RESOURCES TO NICHE MODELS,” the entirety of both which are incorporated herein by reference.

### FIELD OF THE INVENTION

The present invention generally relates to the field of artificial intelligence simulation and modeling. In particular, the present invention is directed to methods and systems for classifying resources to niche models.

### BACKGROUND

Reliable classification of resources to niches remains elusive in existing systems. This is due at least in part to a paucity of accurate methods for predicting suitability of such pairings given available data, as well as to the unreliability and complexity of such data.

### SUMMARY OF THE DISCLOSURE

In an aspect, a system for a system for monitoring niche models using a by-pass engine. The system may be comprised of at least a computing device, wherein the computing device comprises a memory and at least a processor communicatively connected to the memory. The memory contains instructions configuring the at least a processor to generate a niche model, wherein the niche model comprises a plurality of niche data, generate, using a credential classifier, an attribute match datum, wherein the credential classifier is configured to receive a credential datum from a resource, classify, using a trained attribute classifier, the credential datum into the attribute match datum as a function of a plurality of required credentials, match the niche model to a resource model as a function of the attribute match datum, and provide an indication of the matched resource model to a client device associated with the niche model, wherein providing the indication further comprises automatically selecting a single resource, and automatically informing the single resource as a function of the client device

In another aspect, a method for monitoring niche models using a by-pass engine. The method may comprises generating a niche model, wherein the niche model comprises a plurality of niche data, generating, using a credential classifier, an attribute match datum, wherein the credential classifier is configured to receive a credential datum from a resource, classify, using a trained attribute classifier, the credential datum into the attribute match datum as a function of a plurality of required credentials, match the niche model to a resource model as a function of the attribute match datum, and provide an indication of the matched resource model to a client device associated with the niche model, wherein providing the indication further comprises automatically selecting a single resource and automatically informing the single resource as a function of the client device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a system for classifying resources to niche models;

FIG. 2 is a block diagram illustrating exemplary embodiments of fuzzy sets;

FIG. 3 is a block diagram illustrating exemplary embodiments of bivalent sets;

FIG. 4 is a block diagram illustrating an exemplary embodiment of a machine-learning module;

FIG. 5 is a block diagram illustrating an exemplary embodiment of a data architecture;

FIG. 6 is a diagram of an exemplary embodiment of a neural network;

FIG. 7 is a diagram of an exemplary embodiment of a node of a neural network;

FIG. 8 is an exemplary embodiment of an immutable sequential listing;

FIG. 9 is a flow diagram illustrating an exemplary embodiment of a method of classifying resources to niche models;

FIG. 10 is diagrammatic representation of an exemplary embodiment of a display device;

FIG. 11 is a flow diagram of an exemplary method for wage index classification;

FIG. 12 is a flow diagram of an exemplary method for attribute index classification;

FIG. 13 is an illustration of an exemplary user interface;

FIG. 14 is an illustration of an exemplary user interface; and

FIG. 15 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

Embodiments described herein classify niche models to resource models 116 utilizing merit quantitative fields, output quantitative fields, resource data, and/or niche data. Classification may be performed using machine learning processes such as K-nearest neighbors, Naïve Bayes, and/or neural networks; classification may alternatively or additionally be performed using one or more fuzzy matching processes using fuzzy sets and/or inference systems. Quantitative fields, including fuzzy sets, may similarly be generated using machine-learning processes.

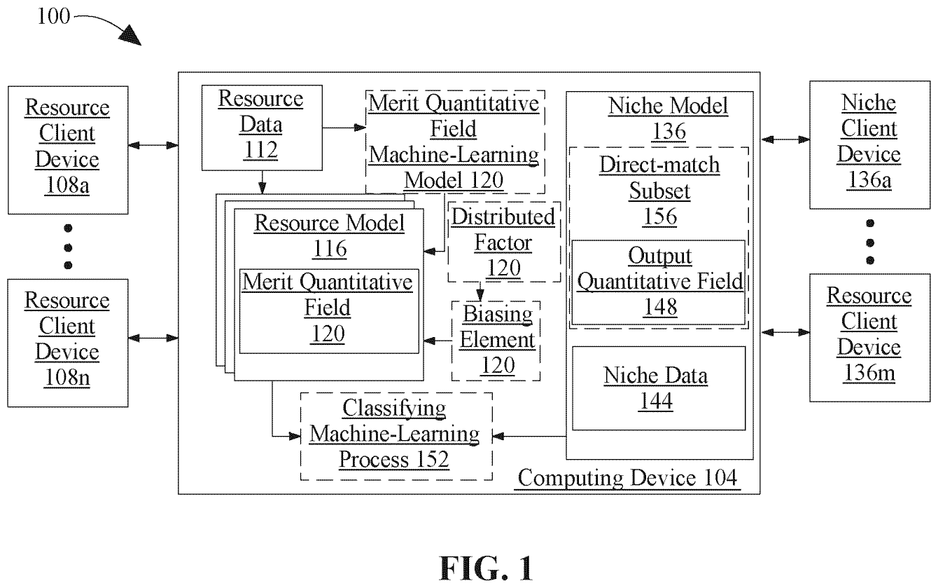

Referring now to FIG. 1, an exemplary embodiment of a system 100 for classifying resources to niche models is illustrated. System includes a computing device 104. Computing device 104 may include any computing device 104 as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device 104 operating independently, or may include two or more computing devices operating in concert, in parallel, sequentially or the like; two or more computing devices may be included together in a single computing device 104 or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device 104, which may operate in parallel, in series, redundantly, or in any other manner used for distribution of tasks or memory between computing devices. Computing device 104 may be implemented using a “shared nothing” architecture in which data is cached at the worker, in an embodiment, this may enable scalability of system 100 and/or computing device 104.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

In an embodiment, and still referring to FIG. 1, computing device 104 is configured to receive, from one or more resource client devices 108a-n, a plurality of resource data 112 corresponding to a plurality of resources. A “resource,” as used in this disclosure, is a person or entity seeking to perform a role in an organization, such as a prospective employee, contractor, gig worker, or the like. For the purposes of this disclosure, “resource data” is any data describing a resource, aside from a merit quantitative field 120 as described below, including according to any examples as described below. Resource client device 108a-n may be implemented, without limitation, in any manner suitable for implementation of computing device 104 as described above, and may include, without limitation, any suitable device operated by and/or belonging to a resource, including a mobile device such as a smartphone, tablet or the like, a laptop, a desktop computer, a workstation, or any other such device that may occur to a person skilled in the art upon reviewing the entirety of this disclosure.

With continued reference to FIG. 1, resource data 112 may include a credential datum. For the purposes of this disclosure, “credential datum” is any datum relating to a user's qualifications to perform a given job function. A credential datum may include any credential or certification a candidate has received from any governing body to demonstrate a candidate's qualifications, achievements, personal qualities, or aspects of a candidate's background. In a non-limiting example, credential datum may include any certification, certificate of completion, or license such as driver's license, commercial driver's license, a law license, a medical license, nursing license, professional engineers license, pilots license, pharmacy license, and the like. Additionally, credential datum may include any degrees or educational certifications a candidate may have obtained. Credential datum may include a total number of hours a candidate has placed into a given job and/or trade. Credential datum may be self-reported by a candidate. Credential datum may also be imported from a social network, resume, Curriculum vitae, a human resource website, and the like. In embodiments, credential datum may be generated as a function of searching a database as using a resources personal information such as name, date of birth, certification identification number (ex. Bar roll number, nursing license number, etc.), social security number, credential expiration date, and the like. In embodiments, the computing device 104 may be configured to send a notification (i.e. email, text, push notification, call, etc.) to the resource to notify them of a coming expiration date on their credential. In a non-limiting example, a resource's credentials expire on Dec. 7, 2022, a computing device 104 may be configured to send the resource a notification 90 days prior to the expiration of the credential. For instance, and without limitation, credential datum may be the same or substantially similar to the credential datum disclosed within U.S. patent application Ser. No. 17/744,044 and titled “APPARATUS FOR AUTOMATIC CREDENTIAL CLASSIFICATION,” which is incorporated herein by reference in its entirety.

With continued reference to FIG. 1, computing device 104 may be configured to authenticate credential datum using an authentication process. As used in the current disclosure, “authentication process” is a process wherein a candidate's credential datum is authenticated. In an embodiment, this may include verifying professional licenses, degrees, certifications, employment history, checking references. This process may require a candidate to submit documents that verify his or her credentials. For example, a candidate may have to provide an official transcript from a college or university to verify completion of a degree. A computing device 104 may then verify the credentials by contacting the various governing bodies, past employers, and or websites. For example, a candidate, who is an attorney may submit paperwork denoting that they are a member of a Bar Association. Computing device 104 may verify that the candidates a member in good standing with the bar by searching the Bar Association's website and/or verifying a candidates paperwork. In other embodiments, Computing device 104 may be configured to verify a candidates references A computing device 104 may send an automated email to the candidate's references to verify the candidate's credentials or requesting a letter of recommendation.

With continued reference to FIG. 1, computing device 104 is configured to generate a plurality of resource models 116. A “resource model,” as used in this disclosure, is a data structure representing a corresponding resource in system 100. Resource model 116 may be implemented in any manner suitable for implementation of a data structure that includes data as described in further detail below. Generating the plurality of resource models 116 may include deriving, for each resource and as a function of the plurality of resource data 112, a merit quantitative field 120. A “merit quantitative field,” as used in this disclosure, is a quantitative field representing a cost or value associated with a resource. A merit quantitative field 120 may include, without limitation, an hourly or other wage, a salary, a flat fee for services, or the like. A “quantitative field,” as used in this disclosure, is a quantitative value or set, such as a number, a range of numbers, an n-tuple of numbers, or the like. In an embodiment, merit quantitative field 120 may include a fuzzy set as described in further detail below. For instance, and without limitation, fuzzy set may include a center and/or centroid at a most likely and/or desirable value, a range weighted by likely preference for resource and/or niche and/or by likelihood of a positive match. Weighting may be tuned according to one or more machine-learning processes as described in further detail below. In an embodiment, and as described in further detail below, weighting may be represented by a membership function curve, for which higher values may represent a greater degree of membership in a fuzzy set, while lower values represent a lower degree of membership therein. Merit quantitative field 120 may include a bivalent set defined on an interval, for instance as described in further detail below.

Still referring to FIG. 1, computing device 104 may derive merit quantitative field 120 by, as a non-limiting example, calculating a number and/or range of numbers representing a merit quantitative value likely to be paid to a resource given supply, demand, and/or other labor market considerations and/or an amount a resource is likely to request, desire or demand. Such calculation may be based on inputs such as, without limitation, a location where work is to take place, whether the opportunity to perform the work and/or job offer is for a job to be commenced on the same day as a process for classification as described herein, or the like, for instance and without limitation as described in further detail below. Alternatively or additionally, computing device 104 may derive merit quantitative field 120 by providing a merit quantitative field machine-learning model 124 and deriving the merit quantitative field 120 as a function of the plurality of resource data 112 and the machine-learning model; this may be performed, without limitation as described in further detail below.

Further referring to FIG. 1, computing device 104 may be configured to generate merit quantitative field 120 by generating a biasing element 128 and generating the merit quantitative field 120 as a function of the biasing element 128. A “biasing element,” as used in this disclosure, is a numerical element added to or otherwise combined with a quantifier such as a merit quantifier to create a modified merit quantifier, for instance, by weighting the quantifier, begin added thereto, or the like. A biasing element 128 may include, for instance a score or rating of resource that indicates a perception among, for instance, peers, licensing boards, managers, or the like of performance and/or social skills of resource. Further examples of biasing elements 128 are described in further detail below. Computing device 104 may be configured to tune the biasing element 128 as a function of a plurality of distributed factors 132. A “distributed factor,” as used herein, is a quantitative and/or quantifiable datum received from at least one additional participant in system and/or a device of such participant, such as without limitation a resource client device 108a-n, niche client device 136a-m, or the like. As a non-limiting example, distributed factors 132 may include ratings from peers, which may be used to calculate, tune, and/or otherwise derive a biasing element 128 such without limitation a social rating. Tuning may be performed using aggregation such as averaging according to an arithmetic and/or multiplicative mean, a weighted sum of inputs or the like, and/or using one or more machine-learning processes and/or models as described in further detail below.

Still referring to FIG. 1, computing device 104 is configured to generate a resource model 116 corresponding to each resource as a function of plurality of resource data 112 and merit quantitative field 120 associated with that resource. Computing device 104 may generate resource model 116 by collecting, aggregating, or otherwise combining resource data 112 corresponding to that resource, for instance and without limitation as described below, together with merit quantitative field 120, for instance as described in further detail below. Elements of resource data 112 used in resource model 116 may include one or more elements to be used in matching resource model 116 to a niche model 140 as described in further detail below.

With continued reference to FIG. 1, computing device 104 is configured to compute a niche model 140. As used in this disclosure, a “niche model” is a data representation of a niche, which is defined as a job opening, gig, temporary or permanent employment opportunity, or the like. A niche model 140 may be implemented using any data structure suitable for implementation of a resource mode. “Computing” as used in this context, refers to retrieval from storage in a database or other memory of and/or accessible to computing device 104 and/or to generation, of niche model 140. Niche model 140 includes a plurality of niche data 144. As used in this disclosure, “niche data” is data describing a niche, which data may be used to match a resource model 116 to a niche model 140. Niche data 144 may include without limitation one or more job requirements, which may be mandatory requirements such as a credential or license required to perform tasks corresponding to the niche and/or requirements that are preferred, desirable, or the like without being mandatory. Niche data 144 may describe one or more circumstances, benefits, perks, or the like of niche, such as a type of office and/or office space, presence or absence of parking and/or public transportation, a number of coworkers, job-site amenities, or the like. A subset of niche data 144 may include a direct-match subset 156, as described in further detail below. Niche model 140 includes an output quantitative field 148. A “niche quantitative field,” as used in this disclosure, is a quantitative field as described above that represents payment offered or potentially offered to a resource selected for niche, which may correspond to any example of merit quantitative fields 120 as described above. Output quantitative field 148 may include a fuzzy set as described in further detail below; fuzzy set may include any form of fuzzy set suitable for use with regard to a fuzzy set representing a merit quantitative field 120. Output quantitative field 148 may include a bivalent set defined on an interval as described in further detail below; bivalent set may include any form of bivalent set suitable for use with regard to a bivalent set representing a merit quantitative field 120. Output quantitative field 148 may be generated using machine learning, in a similar manner to merit quantitative field 120, as described in further detail below.

Alternatively or additionally, and still referring to FIG. 1, niche model may be generated by using a feature learning and/or clustering algorithm to identify clusters of resources representing populations resources having similar characteristic profiles, classifying niche model 140 to a most similar cluster using any classification algorithm as described in this disclosure, and generating niche model 140 by replacing one, a plurality, or all characteristics of niche model 140 with characteristics of a centroid of that cluster.

With continued reference to FIG. 1, niche model 136, resource model 116, and any model mentioned herein, may include a large language model (LLM). A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, novels, blog posts, articles, emails, unstructured data, electronic records, and the like. In some embodiments, training sets of an LLM may include information from one or more public or private databases. As a non-limiting example, training sets may include databases associated with an entity. In some embodiments, training sets may include portions of documents associated with the electronic records 112 correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive an article and apply a probability distribution to the words already typed in a sentence to work out the most likely word to come next in augmented articles. For example, if some words that have already been typed are “You are the highest ranked candidate for this,” then it may be highly likely that the word “position” will come next. An LLM may output such predictions by ranking words by likelihood or a prompt parameter. For the example given above, an LLM may score “you” as the most likely, “your” as the next most likely, “his” or “her” next, and the like. An LLM may include an encoder component and a decoder component.

Still referring to FIG. 1, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1, multi-headed attention in encoder may apply a specific attention mechanism called self-attention. Self-attention allows models such as an LLM or components thereof to associate each word in the input, to other words. As a non-limiting example, an LLM may learn to associate the word “you”, with “how” and “are”. It's also possible that an LLM learns that words structured in this pattern are typically a question and to respond appropriately. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 1, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1, decoder may take this output and add it to the decoder inputs. Decoder may continue decoding until a token is predicted. Decoder may stop decoding once it predicts an end token.

Continuing to refer to FIG. 1, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 1, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data associated with a profile and/or a job posting.

With continued reference to FIG. 1, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

With further reference to FIG. 1, a “feature learning algorithm,” or “clustering algorithm,” as used herein, is a machine-learning algorithm that identifies associations between elements of data in a data set, which may include without limitation a training data set, where particular outputs and/or inputs are not specified. For instance, and without limitation, a feature learning algorithm may detect co-occurrences of sets of physiological data, as defined above, with each other. As a non-limiting example, feature learning algorithm may detect co-occurrences of gene combinations, as defined above, with each other. Computing device may perform a feature learning algorithm by dividing physiological data from a given person into various sub-combinations of such data to create physiological data sets as described above, and evaluate which physiological data sets tend to co-occur with which other physiological data sets; for instance, where physiological state data includes genetic sequences, computing device may divide each genetic sequence into individual genes and evaluate which individual genes and/or combinations thereof tend to co-occur with which other individual genes, and/or other physiological data. In an embodiment, first feature learning algorithm may perform clustering of data.

Continuing refer to FIG. 1, a feature learning and/or clustering algorithm may be implemented, as a non-limiting example, using a k-means clustering algorithm. A “k-means clustering algorithm” as used in this disclosure, includes cluster analysis that partitions n observations or unclassified cluster data entries into k clusters in which each observation or unclassified cluster data entry belongs to the cluster with the nearest mean, using, for instance behavioral training set as described above. “Cluster analysis” as used in this disclosure, includes grouping a set of observations or data entries in way that observations or data entries in the same group or cluster are more similar to each other than to those in other groups or clusters. Cluster analysis may be performed by various cluster models that include connectivity models such as hierarchical clustering, centroid models such as k-means, distribution models such as multivariate normal distribution, density models such as density-based spatial clustering of applications with nose (DBSCAN) and ordering points to identify the clustering structure (OPTICS), subspace models such as biclustering, group models, graph-based models such as a clique, signed graph models, neural models, and the like. Cluster analysis may include hard clustering whereby each observation or unclassified cluster data entry belongs to a cluster or not. Cluster analysis may include soft clustering or fuzzy clustering whereby each observation or unclassified cluster data entry belongs to each cluster to a certain degree such as for example a likelihood of belonging to a cluster; for instance, and without limitation, a fuzzy clustering algorithm may be used to identify clustering of gene combinations with multiple disease states, and vice versa. Cluster analysis may include strict partitioning clustering whereby each observation or unclassified cluster data entry belongs to exactly one cluster. Cluster analysis may include strict partitioning clustering with outliers whereby observations or unclassified cluster data entries may belong to no cluster and may be considered outliers. Cluster analysis may include overlapping clustering whereby observations or unclassified cluster data entries may belong to more than one cluster. Cluster analysis may include hierarchical clustering whereby observations or unclassified cluster data entries that belong to a child cluster also belong to a parent cluster.

Still referring to FIG. 1, computing device may generate a k-means clustering algorithm receiving unclassified physiological state data and outputs a definite number of classified data entry clusters wherein the data entry clusters each contain cluster data entries. K-means algorithm may select a specific number of groups or clusters to output, identified by a variable “k.” Generating a k-means clustering algorithm includes assigning inputs containing unclassified data to a “k-group” or “k-cluster” based on feature similarity. Centroids of k-groups or k-clusters may be utilized to generate classified data entry cluster. K-means clustering algorithm may select and/or be provided “k” variable by calculating k-means clustering algorithm for a range of k values and comparing results. K-means clustering algorithm may compare results across different values of k as the mean distance between cluster data entries and cluster centroid. K-means clustering algorithm may calculate mean distance to a centroid as a function of k value, and the location of where the rate of decrease starts to sharply shift, this may be utilized to select a k value. Centroids of k-groups or k-cluster include a collection of feature values which are utilized to classify data entry clusters containing cluster data entries. K-means clustering algorithm may act to identify clusters of closely related physiological data, which may be provided with user cohort labels; this may, for instance, generate an initial set of user cohort labels from an initial set of user physiological data of a large number of users, and may also, upon subsequent iterations, identify new clusters to be provided new user cohort labels, to which additional user physiological data may be classified, or to which previously used user physiological data may be reclassified.

With continued reference to FIG. 1, generating a k-means clustering algorithm may include generating initial estimates for k centroids which may be randomly generated or randomly selected from unclassified data input. K centroids may be utilized to define one or more clusters. K-means clustering algorithm may assign unclassified data to one or more k-centroids based on the squared Euclidean distance by first performing a data assigned step of unclassified data. K-means clustering algorithm may assign unclassified data to its nearest centroid based on the collection of centroids ci of centroids in set C. Unclassified data may be assigned to a cluster based on [symbol] dist(ci, x)², where argmin includes argument of the minimum, ci includes a collection of centroids in a set C, and dist includes standard Euclidean distance. K-means clustering module may then recompute centroids by taking mean of all cluster data entries assigned to a centroid's cluster. This may be calculated based on ci=1/|Si|Σxi [symbol] Si^{xi}. K-means clustering algorithm may continue to repeat these calculations until a stopping criterion has been satisfied such as when cluster data entries do not change clusters, the sum of the distances have been minimized, and/or some maximum number of iterations has been reached.

Still referring to FIG. 1, k-means clustering algorithm may be configured to calculate a degree of similarity index value. A “degree of similarity index value” as used in this disclosure, includes a distance measurement indicating a measurement between each data entry cluster generated by k-means clustering algorithm and a selected physiological data set. Degree of similarity index value may indicate how close a particular combination of genes, negative behaviors and/or negative behavioral propensities is to being classified by k-means algorithm to a particular cluster. K-means clustering algorithm may evaluate the distances of the combination of genes, negative behaviors and/or negative behavioral propensities to the k-number of clusters output by k-means clustering algorithm. Short distances between a set of physiological data and a cluster may indicate a higher degree of similarity between the set of physiological data and a particular cluster. Longer distances between a set of physiological behavior and a cluster may indicate a lower degree of similarity between a physiological data set and a particular cluster. With continued reference to FIG. 1, k-means clustering algorithm selects a classified data entry cluster as a function of the degree of similarity index value. In an embodiment, k-means clustering algorithm may select a classified data entry cluster with the smallest degree of similarity index value indicating a high degree of similarity between a physiological data set and the data entry cluster. Alternatively or additionally k-means clustering algorithm may select a plurality of clusters having low degree of similarity index values to physiological data sets, indicative of greater degrees of similarity. Degree of similarity index values may be compared to a threshold number indicating a minimal degree of relatedness suitable for inclusion of a set of physiological data in a cluster, where degree of similarity indices a-n falling under the threshold number may be included as indicative of high degrees of relatedness. The above-described illustration of feature learning using k-means clustering is included for illustrative purposes only and should not be construed as limiting potential implementation of feature learning algorithms; persons skilled in the art, upon reviewing the entirety of this disclosure, will be aware of various additional or alternative feature learning approaches that may be used consistently with this disclosure. Clustering and/or identification of cluster centroids may alternatively or additionally be performed using particle swarm optimization, ant-colony optimization, neural network-based clustering algorithms, genetic algorithms, or any other suitable process that may occur to a person skilled in the art upon reviewing the entirety of this disclosure.

With continued reference to FIG. 1, computing device 104 is configured to combine niche model 140 with at least a selected resource model 116 corresponding to a selected resource of the plurality of resources. “Combination,” as used herein, refers to matching and/or associating niche model 140 with at least a selected resource model 116, for instance by identifying at least a resource associated with at least a selected resource model 116 that is suitable for filling, or performing tasks associate with, niche. Combination may be accomplished, without limitation, by generating and/or recording an element of data indicating that resource represented by resource model 116 has been selected for a niche represented by niche model 140. Such association may be recorded by linking resource model 116 or an identifying data of resource model 116 to niche model 140 and/or identifying data of niche model 140 using a data record, textual string, inclusion of one data structure in the other, and/or inclusion of both in a shared data structure. Computing device 104 may combine niche model 140 with at least a selected resource model 116 by classifying the output quantitative field 148 to at least a selected merit quantitative field 120 of the at least a selected resource model 116. “Classification” or “classifying,” as used herein is defined as any process that identifies two values as matching one another. Classification may include, without limitation, numerical equivalency and/or comparison; for instance, classification may include determination that a merit quantitative field 120 represented by a single number is less than or equal to a single number representing an output quantitative field 148, and/or is within some threshold range above and/or below such single number representing an output quantitative field 148. As a further non-limiting example, classification may include identification of a degree of match between a fuzzy set and/or single value representing a merit quantitative field 120 and a fuzzy set and/or single number representing an output quantitative field 148, which degree of match may be compared to a threshold, which may include a predefined threshold, as described in further detail below. Classification may alternatively or additionally be performed using a classification machine-learning process and/or a classifier, as described in further detail below, where classifier may classify based on output quantitative field 148 and merit quantitative field 120 as well as one or more additional fields of niche model 140 and resource model 116. Computing device 104 is configured to combine niche model 140 with at least a selected resource by classifying at least a niche datum of plurality of niche data 144 to at least a datum of plurality of resource data 112; such classification may be performed according to any process described above, including without limitation using comparisons of fuzzy sets and/or bivalent sets defined on a range, which sets may represent resource data 112, niche data 144, or the like.

In an embodiment, and with further reference to FIG. 1, computing device 104 may combine the niche model 140 to the at least a selected resource model 116 using a classifying machine-learning process 152. A “classifying machine-learning process,” as used in this disclosure, is a machine-learning process, as defined in further detail below, which produces and/or comprises a classifier. A “classifier,” as used in this disclosure is a machine-learning model, such as a mathematical model, neural net, or program generated by a classification machine-learning process, which may include a machine learning algorithm as described in further detail below, known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Computing device 104 and/or another device may generate a classifier using a classification algorithm, defined as a process whereby a computing device 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, in a non-limiting example, the classifier may be the same or substantially the same as the classifier described in attorney docket number 1519-002USU1, U.S. patent application Ser. No. 17/743,958, filed on May 13, 2022, titled “APPARATUS AND METHOD FOR WAGE INDEX CLASSIFICATION,” which is incorporated by reference herein in its entirety.

With continued reference to FIG. 1, in a non-limiting example, the classifier may be the same or substantially the same as the classifier described in attorney docket number 1519-004USU1, U.S. patent application Ser. No. 17/744,044, filed on May 13, 2022, titled “APPARATUS AND METHOD FOR AUTOMATIC CREDENTIAL CLASSIFICATION,” which is incorporated by reference herein in its entirety.

Still referring to FIG. 1, computing device 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, computing device 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values. Classification may alternatively or additionally be performed using neural networks and/or deep learning networks.

Still referring to FIG. 1, computing device 104 may be configured to combine the niche model 140 to the at least a selected resource model 116 by combining the niche model 140 to a single resource model 116 corresponding to a single resource of the plurality of resources. In other words, computing device 104 may automatically select a single resource to be hired for or otherwise fill niche, who may be automatically informed via a corresponding resource client device 108a-n of selection. Combining niche model 140 to single resource model 116 may include defining a direct-match subset 156 of the plurality of niche elements. A “direct-match subset,” as used in this disclosure, is a subset of niche data 144 and/or output quantitative field 148 that, if positively matched and/or classified to corresponding resource data 112 elements and/or merit quantitative field 120 of a single resource will result in selection of that single resource for immediate association with niche. Computing device 104 may classify a set of resource data 112 of plurality of resource data 112 corresponding to single resource model 116 to direct-match subset 156, where classification may be performed according to any form of classification as described in this disclosure, including without limitation numerical comparison, comparison of bivalent and/or fuzzy sets, and/or classification using a classifier implemented as described herein. Computing device 104 may classify merit quantitative field 120 of single resource model 116 to output quantitative field 148, where classification may be performed according to any form of classification as described in this disclosure.

With continued reference to FIG. 1, computing device 104 is configured to provide an indication of the at least a selected resource model 116 to a client device of the niche model 140. Indication may be provided using any suitable form of electronic communication, including without limitation push notifications, text messaging, instant messaging, electronic mail (“email”) or the like. One or more messages may be generated using templates, such as email templates; templates may have defined fields in a textual body, and computing device 104 may replace such defined fields with niche data 144, resource data 112, and/or other data retrieved and/or generated in connection with methods or method steps described in this disclosure.

With continued reference to FIG. 1, computing device 104 may be configured to confirm the arrival of a resource at a place of work using an attendance confirmation datum 160. An “attendance confirmation datum,” as used in this disclosure, is an element of information associated with a resource that may be used to verify an identity of the resource and/or to identify the arrival and departure of the resources from a place of work. Attendance confirmation maybe considered to be a process or action of verifying an identity of a user or process. The same (or different) attendance confirmation datum 160 may be used to authorize a resource to enter the workplace. Attendance confirmation 160 may include, for example and without limitation, password-based authentication, multi-factor authentication, certificate-based authentication, biometric authentication, token-based authentication, and the like, among others. Attendance confirmation 160 may include information, data or credentials on or relating to, for example, and without limitation, employee identification number, radio-frequency identification (RFID) associated with a resource, registration and/or licensing of number of the employee, job title of the resource, and the like. In some cases, attendance confirmation 160 may include a password or passcode which has to be entered or scanning a resource badge associated with the resource, additionally or alternatively, to other arrival confirmation, data or information. Attendance confirmation 160 may also be transmitted to computing device 104 by an independent device in possession of the resource, for example and without limitation, from a smartphone or a tablet. In a non-limiting embodiment, attendance confirmation datum160 may include a digital signature, for example, signed by a computing device on electric aircraft such as flight controller, or the like.

With continued reference to FIG. 1, attendance confirmation datum 160 may be generated through the uses of scanning, swiping, or entering an employee credential into computing device 104. In an embodiment, computing device 104 may be configured to receive an employee credential from a resource identification device. As used in the current disclosure, “resource identification device” is a device used to identify an employee. In embodiments and resource identification device, may be an employee badge or identification card with a photo for identification. An employee badge may include an RFID component, a magnetic stripe, Barcode, or Quick Response code. A resource identification device may be configured to transmit a credential to a computing device 104. A “credential” as described in the entirety of this disclosure, is any datum representing an identity, attribute, code, and/or characteristic specific to a user, a user device, and/or an electric aircraft. In some embodiments a credential may include any Attendance confirmation datum 160 described herein above. For example and without limitation, the credential may include a username and password unique to the user, the user device, and/or the electric aircraft. The username and password may include any alpha-numeric character, letter case, and/or special character. As a further example and without limitation, the credential may include a digital certificate, such as a PKI certificate. The remote user device and/or the electric aircraft may include an additional computing device, such as a mobile device, laptop, desktop computer, or the like; as a non-limiting example, the user device may be a computer and/or smart phone operated by a resource. As a further embodiment, computing device 104 may be configured to receive a credential from an admin device. The admin device may include any additional computing device as described above in further detail, wherein the additional computing device is utilized by/associated with an employee of an administrative body, such as an employee of a manager or a human resources official.

In an embodiment, methods and systems described herein may perform or implement one or more aspects of a cryptographic system. In one embodiment, a cryptographic system is a system that converts data from a first form, known as “plaintext,” which is intelligible when viewed in its intended format, into a second form, known as “ciphertext,” which is not intelligible when viewed in the same way. Ciphertext may be unintelligible in any format unless first converted back to plaintext. In one embodiment, a process of converting plaintext into ciphertext is known as “encryption.” Encryption process may involve the use of a datum, known as an “encryption key,” to alter plaintext. Cryptographic system may also convert ciphertext back into plaintext, which is a process known as “decryption.” Decryption process may involve the use of a datum, known as a “decryption key,” to return the ciphertext to its original plaintext form. In embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the ciphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either encryption or decryption key cannot be readily deduced without additional secret knowledge, even given the possession of a corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which an encryption key involves the use of numbers that are products of very large prime numbers, but a decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=−R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

In some embodiments, systems and methods described herein produce cryptographic hashes, also referred to by the equivalent shorthand term “hashes.” A cryptographic hash, as used herein, is a mathematical representation of a lot of data, such as files or blocks in a block chain as described in further detail below; the mathematical representation is produced by a lossy “one-way” algorithm known as a “hashing algorithm.” Hashing algorithm may be a repeatable process; that is, identical lots of data may produce identical hashes each time they are subjected to a particular hashing algorithm. Because hashing algorithm is a one-way function, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. However, the statistical likelihood of a computer of a set of computers simultaneously attempting to guess the missing data within a useful timeframe may be higher, permitting mining protocols as described in further detail below.

In an embodiment, hashing algorithm may demonstrate an “avalanche effect,” whereby even extremely small changes to lot of data produce drastically different hashes. This may thwart attempts to avoid the computational work necessary to recreate a hash by simply inserting a fraudulent datum in data lot, enabling the use of hashing algorithms for “tamper-proofing” data such as data contained in an immutable ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially adding up to significant processing delays where repeated hashing, or hashing of large quantities of data, is required, for instance as described in further detail below. Examples of hashing programs include, without limitation, SHA256, a NIST standard; further current and past hashing algorithms include Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)-family hash functions such as PMAC, OMAC, VMAC, HMAC, and UMAC, Poly1305-AES, Elliptic Curve Only Hash (“ECOH”) and similar hash functions, Fast-Syndrome-based (FSB) hash functions, GOST hash functions, the Grøstl hash function, the HAS-160 hash function, the JH hash function, the RadioGatún hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision-resistance requirements, a brute-force or “birthday attack” may to detect collision may be on the order of O(2^{n/2}) for n output bits; thus, it may take on the order of 2²⁵⁶ operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

Continuing to refer to FIG. 1, a “secure proof,” as used in this disclosure, is a protocol whereby an output is generated that demonstrates possession of a secret, such as device-specific secret, without demonstrating the entirety of the device-specific secret; in other words, a secure proof by itself, is insufficient to reconstruct the entire device-specific secret, enabling the production of at least another secure proof using at least a device-specific secret. A secure proof may be referred to as a “proof of possession” or “proof of knowledge” of a secret. Where at least a device-specific secret is a plurality of secrets, such as a plurality of challenge-response pairs, a secure proof may include an output that reveals the entirety of one of the plurality of secrets, but not all of the plurality of secrets; for instance, secure proof may be a response contained in one challenge-response pair. In an embodiment, proof may not be secure; in other words, proof may include a one-time revelation of at least a device-specific secret, for instance as used in a single challenge-response exchange.

Secure proof may include a zero-knowledge proof, which may provide an output demonstrating possession of a secret while revealing none of the secret to a recipient of the output; zero-knowledge proof may be information-theoretically secure, meaning that an entity with infinite computing power would be unable to determine secret from output. Alternatively, zero-knowledge proof may be computationally secure, meaning that determination of secret from output is computationally infeasible, for instance to the same extent that determination of a private key from a public key in a public key cryptographic system is computationally infeasible. Zero-knowledge proof algorithms may generally include a set of two algorithms, a prover algorithm, or “P,” which is used to prove computational integrity and/or possession of a secret, and a verifier algorithm, or “V” whereby a party may check the validity of P. Zero-knowledge proof may include an interactive zero-knowledge proof, wherein a party verifying the proof must directly interact with the proving party; for instance, the verifying and proving parties may be required to be online, or connected to the same network as each other, at the same time. Interactive zero-knowledge proof may include a “proof of knowledge” proof, such as a Schnorr algorithm for proof on knowledge of a discrete logarithm. In a Schnorr algorithm, a prover commits to a randomness r, generates a message based on r, and generates a message adding r to a challenge c multiplied by a discrete logarithm that the prover is able to calculate; verification is performed by the verifier who produced c by exponentiation, thus checking the validity of the discrete logarithm. Interactive zero-knowledge proofs may alternatively or additionally include sigma protocols. Persons skilled in the art, upon reviewing the entirety of this disclosure, will be aware of various alternative interactive zero-knowledge proofs that may be implemented consistently with this disclosure.

Alternatively, zero-knowledge proof may include a non-interactive zero-knowledge, proof, or a proof wherein neither party to the proof interacts with the other party to the proof; for instance, each of a party receiving the proof and a party providing the proof may receive a reference datum which the party providing the proof may modify or otherwise use to perform the proof. As a non-limiting example, zero-knowledge proof may include a succinct non-interactive arguments of knowledge (ZK-SNARKS) proof, wherein a “trusted setup” process creates proof and verification keys using secret (and subsequently discarded) information encoded using a public key cryptographic system, a prover runs a proving algorithm using the proving key and secret information available to the prover, and a verifier checks the proof using the verification key; public key cryptographic system may include RSA, elliptic curve cryptography, ElGamal, or any other suitable public key cryptographic system. Generation of trusted setup may be performed using a secure multiparty computation so that no one party has control of the totality of the secret information used in the trusted setup; as a result, if any one party generating the trusted setup is trustworthy, the secret information may be unrecoverable by malicious parties. As another non-limiting example, non-interactive zero-knowledge proof may include a Succinct Transparent Arguments of Knowledge (ZK-STARKS) zero-knowledge proof. In an embodiment, a ZK-STARKS proof includes a Merkle root of a Merkle tree representing evaluation of a secret computation at some number of points, which may be 1 billion points, plus Merkle branches representing evaluations at a set of randomly selected points of the number of points; verification may include determining that Merkle branches provided match the Merkle root, and that point verifications at those branches represent valid values, where validity is shown by demonstrating that all values belong to the same polynomial created by transforming the secret computation. In an embodiment, ZK-STARKS does not require a trusted setup.

Zero-knowledge proof may include any other suitable zero-knowledge proof. Zero-knowledge proof may include, without limitation bulletproofs. Zero-knowledge proof may include a homomorphic public-key cryptography (hPKC)-based proof. Zero-knowledge proof may include a discrete logarithmic problem (DLP) proof. Zero-knowledge proof may include a secure multi-party computation (MPC) proof. Zero-knowledge proof may include, without limitation, an incrementally verifiable computation (IVC). Zero-knowledge proof may include an interactive oracle proof (IOP). Zero-knowledge proof may include a proof based on the probabilistically checkable proof (PCP) theorem, including a linear PCP (LPCP) proof. Persons skilled in the art, upon reviewing the entirety of this disclosure, will be aware of various forms of zero-knowledge proofs that may be used, singly or in combination, consistently with this disclosure.

In an embodiment, secure proof is implemented using a challenge-response protocol. In an embodiment, this may function as a one-time pad implementation; for instance, a manufacturer or other trusted party may record a series of outputs (“responses”) produced by a device possessing secret information, given a series of corresponding inputs (“challenges”), and store them securely. In an embodiment, a challenge-response protocol may be combined with key generation. A single key may be used in one or more digital signatures as described in further detail below, such as signatures used to receive and/or transfer possession of crypto-currency assets; the key may be discarded for future use after a set period of time. In an embodiment, varied inputs include variations in local physical parameters, such as fluctuations in local electromagnetic fields, radiation, temperature, and the like, such that an almost limitless variety of private keys may be so generated. Secure proof may include encryption of a challenge to produce the response, indicating possession of a secret key. Encryption may be performed using a private key of a public key cryptographic system, or using a private key of a symmetric cryptographic system; for instance, trusted party may verify response by decrypting an encryption of challenge or of another datum using either a symmetric or public-key cryptographic system, verifying that a stored key matches the key used for encryption as a function of at least a device-specific secret. Keys may be generated by random variation in selection of prime numbers, for instance for the purposes of a cryptographic system such as RSA that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

Keys may be generated by random variation in selection of prime numbers, for instance for the purposes of a cryptographic system such as secret that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

Cryptographic system may be configured to generate a session-specific secret. Session-specific secret may include a secret, which may be generated according to any process as described above, that uniquely identifies a particular instance of an attested boot and/or loading of software monitor. Session-specific secret may include without limitation a random number. Session-specific secret may be converted to and/or added to a secure proof, verification datum, and/or key according to any process as described above for generation of a secure proof, verification datum, and/or key from a secret or “seed”; session-specific secret, a key produced therewith, verification datum produced therewith, and/or a secure proof produced therewith may be combined with module-specific secret, a key produced therewith, a verification datum produced therewith, and/or a secure proof produced therewith, such that, for instance, a software monitor and/or other signed element of attested boot and/or attested computing may include secure proof both of session-specific secret and of module-specific secret. In an embodiment, session-specific secret may be usable to identify that a given computation has been performed during a particular attested session, just as device-specific secret may be used to demonstrate that a particular computation has been produced by a particular device. This may be used, e.g., where secure computing module and/or any component thereof is stateless, such as where any such element has no memory that may be overwritten and/or corrupted.

Still referring to FIG. 1, a “digital signature,” as used herein, includes a secure proof of possession of a secret by a signing device, as performed on provided element of data, known as a “message.” A message may include an encrypted mathematical representation of a file or other set of data using the private key of a public key cryptographic system. Secure proof may include any form of secure proof as described above, including without limitation encryption using a private key of a public key cryptographic system as described above. Signature may be verified using a verification datum suitable for verification of a secure proof, for instance, where secure proof is enacted by encrypting message using a private key of a public key cryptographic system, verification may include decrypting the encrypted message using the corresponding public key and comparing the decrypted representation to a purported match that was not encrypted; if the signature protocol is well-designed and implemented correctly, this means the ability to create the digital signature is equivalent to possession of the private decryption key and/or device-specific secret. Likewise, if a message making up a mathematical representation of file is well-designed and implemented correctly, any alteration of the file may result in a mismatch with the digital signature; the mathematical representation may be produced using an alteration-sensitive, reliably reproducible algorithm, such as a hashing algorithm as described above. A mathematical representation to which the signature may be compared may be included with signature, for verification purposes; in other embodiments, the algorithm used to produce the mathematical representation may be publicly available, permitting the easy reproduction of the mathematical representation corresponding to any file.

Further viewing FIG. 1, in some embodiments, digital signatures may be combined with or incorporated in digital certificates. In one embodiment, a digital certificate is a file that conveys information and links the conveyed information to a “certificate authority” that is the issuer of a public key in a public key cryptographic system. Certificate authority in some embodiments contains data conveying the certificate authority's authorization for the recipient to perform a task. The authorization may be the authorization to access a given datum. The authorization may be the authorization to access a given process. In some embodiments, the certificate may identify the certificate authority. The digital certificate may include a digital signature.

With continued reference to FIG. 1, in some embodiments, a third party such as a certificate authority (CA) is available to verify that the possessor of the private key is a particular entity; thus, if the certificate authority may be trusted, and the private key has not been stolen, the ability of an entity to produce a digital signature confirms the identity of the entity and links the file to the entity in a verifiable way. Digital signature may be incorporated in a digital certificate, which is a document authenticating the entity possessing the private key by authority of the issuing certificate authority and signed with a digital signature created with that private key and a mathematical representation of the remainder of the certificate. In other embodiments, digital signature is verified by comparing the digital signature to one known to have been created by the entity that purportedly signed the digital signature; for instance, if the public key that decrypts the known signature also decrypts the digital signature, the digital signature may be considered verified. Digital signature may also be used to verify that the file has not been altered since the formation of the digital signature.

With continued reference to FIG. 1, attendance confirmation datum 160 may be compared to a resource's timesheet to generate time sheet verification datum 164. As used in the current disclosure, “timesheet verification” is a processes wherein a resources' timesheet is verified against attendance confirmation datum 160. An employee's time sheet may reflect the time, date, and a location that an employee began and ended working for a given shift. A timesheet may also denote information such as length of an employee's shift, what assignments an employee worked on, the supervisor on duty for the shift, and the like. In an embodiment, timesheet verification 164 may include comparing an employee's timesheet with attendance confirmation datum 160 to confirm an employee's arrival, departure, time worked, work location, and the like. If the information on the timesheet and attendance confirmation datum 160 match the timesheet may be considered verified. However, if the information on the timesheet does not match attendance datum 160 the employees timesheet may be flagged. A notification may be sent to a user device associated with a human resources representative denoting that the employee's timesheet has been flagged.

With continued reference to FIG. 1, a computing device 104 may place a resource through a banning protocol 168. As used in the current disclosure, “banning protocol” is a protocol wherein a resource data will not be classified or matched to a niche model. In embodiments, either the resource or the niche model may be placed into the banning protocol wherein they are not eligible to be classified to other resources or niche models as determined by a user.

In other embodiments, banning protocol 168 may be initiated as a function of the resource no longer looking for a job. In embodiments, banning protocol 168 may be initiated as a function of niche model no longer seeking personnel. In other embodiments, banning protocol 168 may occur because the either the resource or the niche model has violated the terms of use of the platform, program, app, or host company. Banning protocol 168 may also be initiated voluntarily by either a resource or niche model.

With continued reference to FIG. 1, a computing device 104 may monitor a niche model using a by-pass engine 172. As used in the current disclosure, “by-pass engine” is a monitoring process for a niche model to ensure that the niche model is filled with a resource from within the platform. In embodiments, the platform may have terms and conditions that state that a niche model cannot hire a resource outside of the platform for a pre-determined period of time after being matched/paired to said resource. A by-pass engine 172 may monitor a resource model during that pre-determined period of time. In embodiments, monitoring may include tracking the human resource records, social media, company website of a given employer for new hires that may include a resource that was matched to the niche model via the platform. Monitoring may also include any means of monitoring the employment history. The by-pass engine 172 may be initiated as a function of the matching or pairing of niche model to a resource/resource model. In an embodiment, a by-pass engine 172 may track when a when a niche model is removed from the platform after it has been classified to a resource or resource model. A by-pass engine 172 then may automatically send an inquiry via email or other electronic means if the position or job posing has been filled outside of the platform. In embodiments, a by-pass engine may flag a niche models that have been paired with a resource/resource model but have not hired a resources. In other embodiments, a by-pass engine may flag a niche models that have been removed from the platform after being paired with a resource/resource model. As used in the current disclosure, “flag” means to highlight or mark for the purpose of bringing the attention of a user. Flagging a niche model may include sending a notification to a user device that is associated with a platform administrator. Niche models may also be flagged whenever a previously matched resource is hired by a niche model outside of the platform.

With continued reference to FIG. 1, placing a resource in a banning protocol may include placing the resource through a confirmation process. As used in the current disclosure, a “confirmation process” is a process where both the employer and the candidate agree to the terms of the hiring process. In a non-limiting example, a confirmation process may first notify the employer that a candidate has been matched. The employer then may be required to approve the offer of employment before it is sent to the client. At this stage, the employer may verify that the terms of employment may include salary, hourly rate, payment schedule, benefits, start date, work location, length of employment, type of employment, specific job responsibilities, and the like. In some embodiments, computing device 104 may be configured to output terms of employment for the employers approval. After the employer confirms the terms of employment, the final offer is sent to the candidate. Once the candidate accepts the offer the candidate has been automatically hired. In embodiments, this final offer may have a pre-determined time for acceptance. System may automatically prevent matching and/or combination of single resource with additional resource models and/or niche models as a function of the confirmation process; for instance, single resource may be flagged as already matched to a niche model and thus not available to combine with other niche models during a particular time period such as without limitation a period of employment at a location or role represented by niche model.

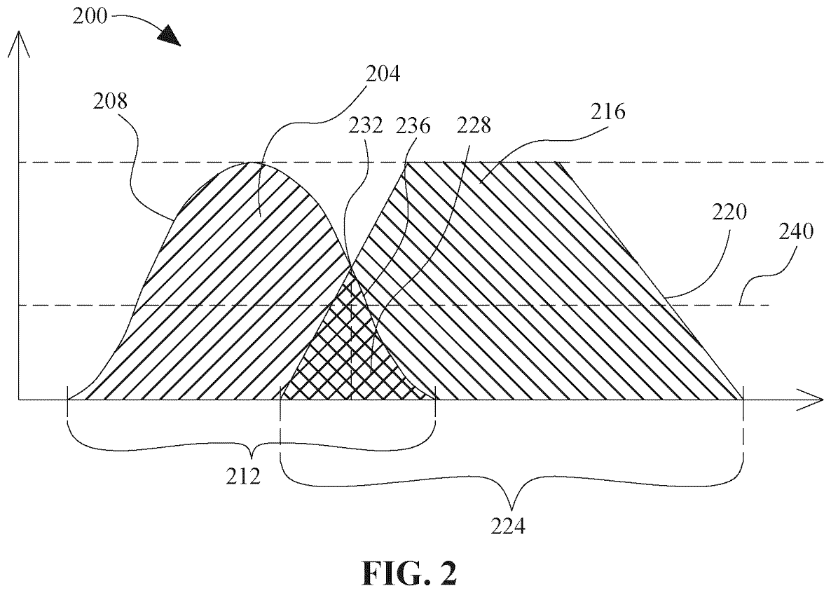

Referring now to FIG. 2, an exemplary embodiment of fuzzy set comparison 200 is illustrated. A first fuzzy set 204 may be represented, without limitation, according to a first membership function 208 representing a probability that an input falling on a first range of values 212 is a member of the first fuzzy set 204, where the first membership function 208 has values on a range of probabilities such as without limitation the interval [0,1], and an area beneath the first membership function 208 may represent a set of values within first fuzzy set 204. Although first range of values 212 is illustrated for clarity in this exemplary depiction as a range on a single number line or axis, first range of values 212 may be defined on two or more dimensions, representing, for instance, a Cartesian product between a plurality of ranges, curves, axes, spaces, dimensions, or the like. First membership function 208 may include any suitable function mapping first range 212 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , & for x > c and x < a \\ \frac{x - a}{b - a} , & for a \leq x < b \\ \frac{c - x}{c - b} , & if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 204 may represent any value or combination of values as described above, including merit quantitative field 120, an output quantitative field 148, any resource datum, any niche datum, and/or any combination of the above. A second fuzzy set 216, which may represent any value which may be represented by first fuzzy set 204, may be defined by a second membership function 220 on a second range 224; second range 224 may be identical and/or overlap with first range 212 and/or may be combined with first range via Cartesian product or the like to generate a mapping permitting evaluation overlap of first fuzzy set 204 and second fuzzy set 216. Where first fuzzy set 204 and second fuzzy set 216 have a region 228 that overlaps, first membership function 208 and second membership function 220 may intersect at a point 232 representing a probability, as defined on probability interval, of a match between first fuzzy set 204 and second fuzzy set 216. Alternatively or additionally, a single value of first and/or second fuzzy set may be located at a locus 236 on first range 212 and/or second range 224, where a probability of membership may be taken by evaluation of first membership function 208 and/or second membership function 220 at that range point. A probability at 228 and/or 232 may be compared to a threshold 240 to determine whether a positive match is indicated. Threshold 240 may, in a non-limiting example, represent a degree of match between first fuzzy set 204 and second fuzzy set 216, and/or single values therein with each other or with either set, which is sufficient for purposes of the matching process; for instance, threshold may indicate a sufficient degree of overlap between merit quantitative field 120 and output quantitative field 148 for combination to occur as described above. There may be multiple thresholds; for instance, a second threshold may indicate a sufficient match for purposes of a direct-match subset 156 as described in this disclosure. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if two resource models 116 have fuzzy sets matching a niche model 140 fuzzy set by having a degree of overlap exceeding a threshold, computing device 104 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple resource models 116 may be presented to a user of a niche client device 136a-m in order of ranking.

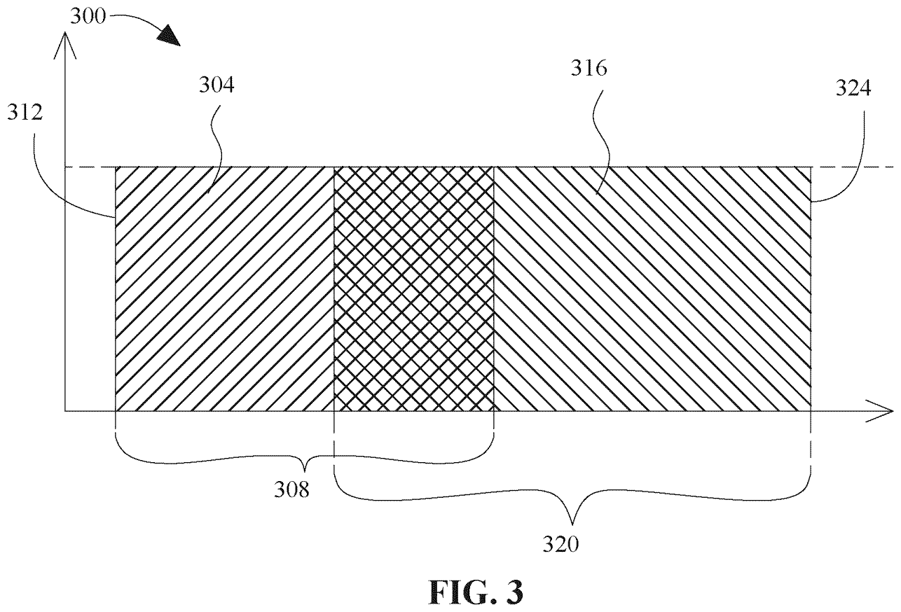

Referring now to FIG. 3, an exemplary embodiment of comparison of bivalent sets on ranges is illustrated. A first bivalent set 304 may be defined on a first range 308, which may have any form suitable for use as a first range 212 for a fuzzy set as described above. In an embodiment, first bivalent set 304 may be defined according to a first characteristic function 312, which may include, without limitation, a step function having output values on a probability interval such as [0,1] or the like; step function may have an output representing 100% or probability of 1 for values falling on first range 308 and zero or a representation of zero probability for values not on first range 308. A second bivalent set 316 may be defined on a second range 320, which may include any range suitable for use as first range 308. Second bivalent set may be defined by a second characteristic function 324, which may include any function suitable for use as first characteristic function 312. In an embodiment a match between first bivalent set 308 and second bivalent set 320 may be established where first range 308 intersects second range 320, and/or where first characteristic function 312 and second characteristic function 324 share at least one point in first range 308 and second range 316 at which both first characteristic function 312 and second characteristic function 324 are non-zero.

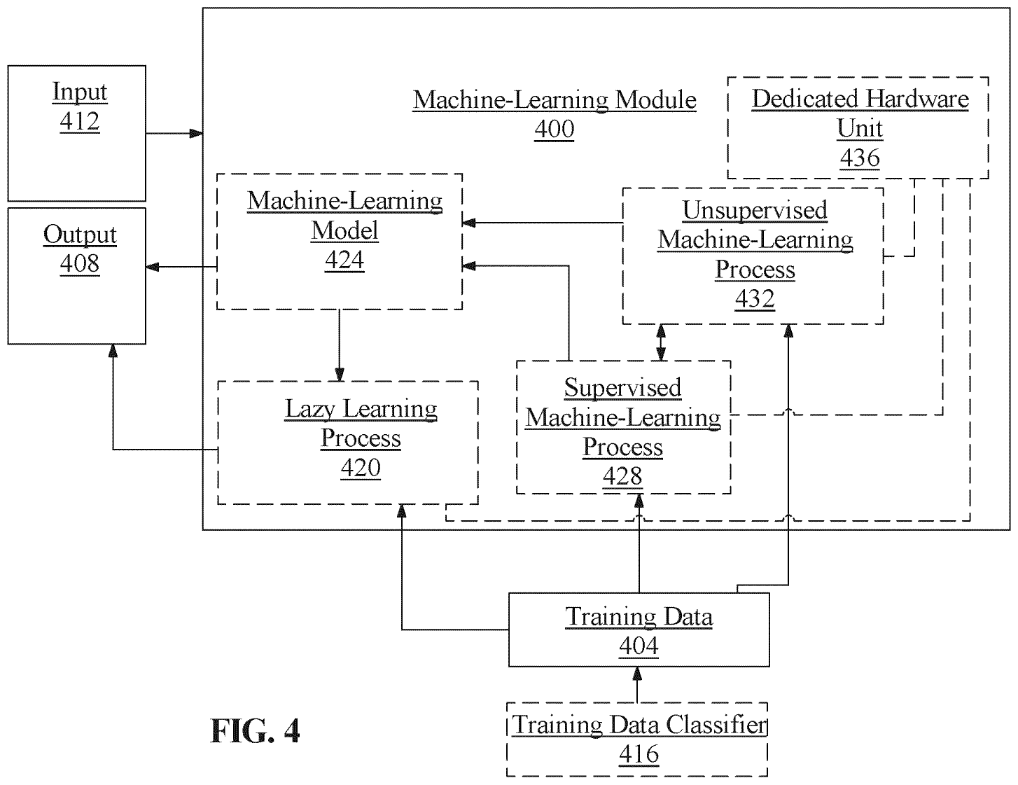

Referring now to FIG. 4 an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 404 to generate an algorithm instantiated in hardware or software logic, data structures, and/or functions that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative example inputs such as, without limitation, a location where work is to take place, whether the opportunity to perform the work and/or job offer is for a job to be commenced on the same day as a process for classification as described herein, and outputs, such as, without limitation, output quantitative field 148.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to a subset of niche data 144 and/or output quantitative field 148 that, if positively matched and/or classified to corresponding resource data 112 elements and/or merit quantitative field 120 of a single resource will result in selection of that single resource for immediate association with niche.

Still referring to FIG. 4, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 4, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 4, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 4, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 4, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 4, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 4, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 4, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 4, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 4, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 4, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation o of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 4, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include input any set of data associated with a profile and/or a job posting as described above as inputs, output quantitative field 148 as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

With further reference to FIG. 4, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 4, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 432 may not require a response variable; unsupervised processes 432may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 4, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 4, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 4, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 4, one or more processes or algorithms described above may be performed by at least a dedicated hardware unit 436. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 436 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 436 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 436 to perform one or more operations described herein, such as evaluation of model and/or algorithm outputs, one-time or iterative updates to parameters, coefficients, weights, and/or biases, and/or any other operations such as vector and/or matrix operations as described in this disclosure.

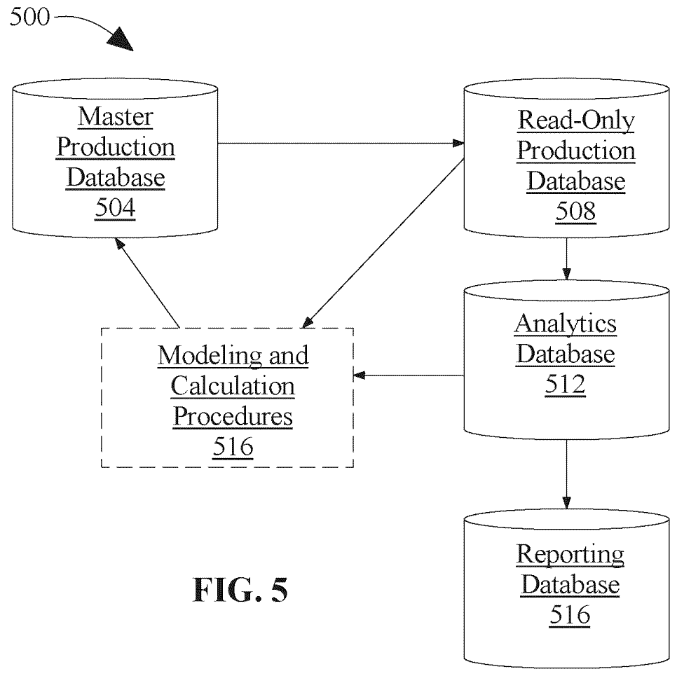

Referring now to FIG. 5, an exemplary database architecture 500 for system 100 is illustrated. Database architecture 500 may include a master production database 504. Master production database 504 may be implemented, without limitation, as a relational master production database 504, a key-value retrieval master production database 504 such as a NOSQL master production database 504, or any other format or structure for use as a master production database 504 that a person skilled in the art would recognize as suitable upon review of the entirety of this disclosure. Master production database 504 may alternatively or additionally be implemented using a distributed data storage protocol and/or data structure, such as a distributed hash table or the like. Master production database 504 may include a plurality of data entries and/or records as described above. Data entries in a master production database 504 may be flagged with or linked to one or more additional elements of information, which may be reflected in data entry cells and/or in linked tables such as tables related by one or more indices in a relational master production database 504. Persons skilled in the art, upon reviewing the entirety of this disclosure, will be aware of various ways in which data entries in a master production database 504 may store, retrieve, organize, and/or reflect data and/or records as used herein, as well as categories and/or populations of data consistently with this disclosure. Master production database 504 may be used to store data used by system 100 as described above, including without limitation resource data 112, merit quantitative fields 120, niche data 144, output quantitative fields 148, combinations of resources and niches, and/or other data concerning and/or describing interactions between niches, resources, and/or system 100, which may include any such data as described in this disclosure. Master production database 504 may be used for retrieval of data to support methods as described in this disclosure, including without limitation methods of classifying resources to niches; for instance, and without limitation, data may be retrieved from master production database 504 for performance of processes and/or process steps as described in this disclosure, including without limitation generation of merit quantitative field 120 and/or niche quantitative field, generation of resource model 116, generation of niche model 140, combination of niche model 140 and resource model 116, transmission of information, templates for transmission of information, or the like.

In an embodiment, and still referring to FIG. 5, master production database 504 may be isolated from some processes and/or modules of system 100 to preserve security and/or data integrity. Master production database 504 may be mirrored to a read-only production database 508 from which data may be retrieved for integration with third-party services and/or generation of scheduled notifications such as job digest emails, and/or job reminder emails and/or push notifications to niches and/or resources. Persons skilled in the art, upon reviewing the entirety of this disclosure, will be aware of various alternative or additional ways in which data retrieved from read-only production database 508 may be used by system 100 for purposes described in this disclosure.

Further referring to FIG. 5, an analytics database 512 may be used to store outputs of calculations regarding statistics and/or other numerical information describing populations of niches and/or resources, outcomes and/or trends from past iterations of methods. Data from analytics database 512 may be used to generate training data or statistics used for matching, classification, or the like.

With continued reference to FIG. 5, a reporting database 516 may be used to generate dashboards for analytical professionals operating system 100, to generate reports describing one or more trends, elements of data, or the like as generated in and/or for one or more iterations of methods described in this disclosure or the like.

In an embodiment, and still referring to FIG. 5, modeling and calculation procedures 516, such as procedures and/or process steps described in this disclosure, and/or to export data to one or more third parties. The above-provided database architecture is provided for exemplary purposes only, and persons skilled in the art, upon reviewing the entirety of this disclosure, will be aware of various alternative or additional configurations that may be used consistently with this disclosure.

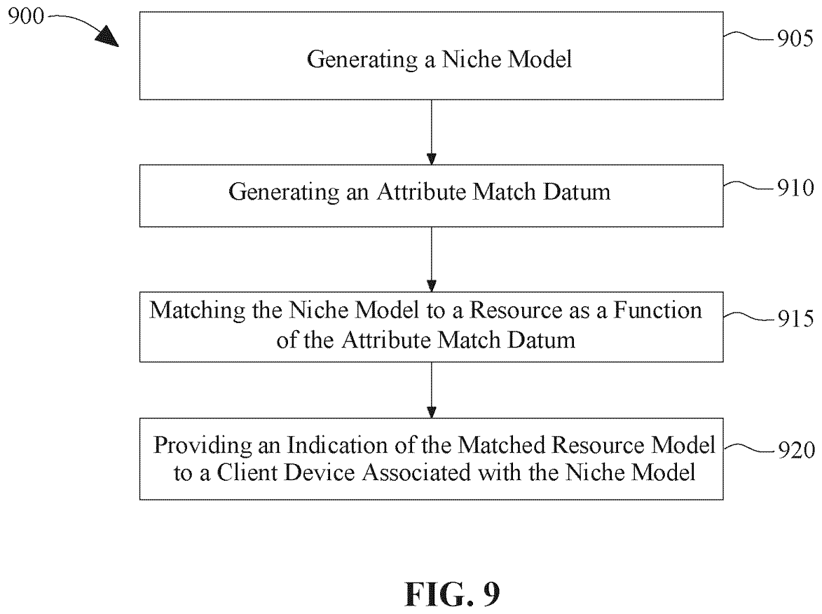

Referring now to FIG. 9, an exemplary embodiment of a method 900 of classifying resource models 116 to niche models 140 is illustrated. At step 905, a computing device 104 receives a plurality of resource data 112 corresponding to a plurality of resources; this may be implemented, without limitation, as described above in reference to FIGS. 1-5. Resource data 112 may include, without limitation, a name or other identifying data of resource, geographical location of a residence and/or current place of work of resource, a range of areas in which resource can work, which may include a radius around the residence of resource, a number of years of experience of the resource, dates and/or times at which resource is available to perform work, data describing work experience such as without limitation types of previous work performed, quality of performance, reviews and/or references, positions previously occupied, durations of gigs and/or positions occupied in the past, or the like, educational attainments such as subjects studied, degrees earned, fields of study, institutions such as universities, trade schools, or the like, professional credentials of resource such as without limitation licenses, data concerning completion of internship, residency requirements, or the like, completion of continuing education requirements, disciplinary records before licensing boards, personal preferences, professional skills, or any other resource data 112 that may occur to persons skilled in the art upon reviewing the entirety of this disclosure. Resource data 112 may include information concerning allergies, disabilities, or other health concerns of resource. Resource data 112 may include information describing equipment and/or computer programs which resource has been trained to use and/or which resource has work experience using. Resource data 112 may include names or other identifying information of one or more persons resource has worked with in the past. Resource data 112 may include disciplinary records, credit history, criminal background check information, or the like.

At step 910, and still referring to FIG. 9, computing device 104 generates a plurality of resource models 116; this may be implemented, without limitation, as described above in reference to FIGS. 1-5. Generating plurality of resource models 116 may include deriving, for each resource and as a function of the plurality of resource data 112, a merit quantitative field 120 and generating a resource model 116 corresponding to the resource as a function of the plurality of resource data 112 and the merit quantitative field 120. Derivation of merit quantitative field 120 may include, as an illustrative example, implementation of dynamic suggested pricing system for suggesting appropriate job rates to resources applying for a niche; derivation may depend, as a non-limiting example, on the personnel (experience, profile completion etc.) and the rates of the previous jobs completed in the city/zip code of the job. Derivation may include, without limitation any process described above, and/or may include recording one or more entries provided by a resource; for instance, resource may choose a desired merit quantitative field 120 by moving one or more sliders on a mobile application and/or a web application. Slider may use color and text to notify personnel if a desired merit quantitative field 120 is appropriate or not, for instance by comparison to a merit quantitative field 120 generated as described above. For instance, if a slider value is within a given range from the suggested rate and/or if the chosen desired rate is lower than the suggested rate, the slider may be colored green, if selected merit quantitative field 120 is slightly higher than a generated merit quantitative field 120, it may be colored yellow and if the desired rate is much higher than the suggested rate the slider may be colored red along with the warning text that the personnel is unlikely to get hired for the job with the chosen desired rate.

As a further example of merit quantitative value derivation, a base rate may be calculated; base rate may be calculated using any process described above. For instance, base rate may be calculated for each pair of a zip code of work location and/or license type of resource desired and/or for each pair of a city of work location and/or license type. Base rate calculation may be a scheduled task performed nightly by a dedicated actor. City/license type and zip/license type tasks may be separate. In an embodiment, calculation may be performed only for zip code areas and cities (which may be referred to collectively herein as “job areas”) that have had completed engagements in the past in order to avoid unneeded calculations. In an embodiment, for each job areas up to 10 previous engagements may be selected and a rate of these engagements may be appended to a sum; these rates may be divided with a weight coefficient used for their original calculation in order to decouple them from parameters of personnel and office that participated in an engagement. This sum may then be divided by ten to obtain a base rate to be used for a particular job area/license type combination. If a job area does not have engagements default base rate may be used, which may be stored in an application configuration. If a job area has less than ten engagements a standard sum calculation may be performed for existing engagements, and virtual engagement rates may be added to a sum until there are ten engagements, after which the sum may be divided by ten. These virtual engagements may have their rate set to a default rate for a license type, which may be stored in application configuration.

A calculated rate may be stored in the database for each job area/license type pair.

In an embodiment, and still referring to FIG. 9, when a job match is created and/or one or more method steps are being performed, a weight coefficient may be calculated for that job match that may determine suggested rate scaling based on personnel and client properties. A default value may have a weight of 1. Depending on properties of resource and/or niche, a coefficient may either increased or decreased by a value that is defined in an application configuration. These properties and values may be given, without limitation, as illustrated for exemplary purposes in the table below:

| | | |
|---|---|---|
| base weight | | 1 |
| Years of experience | 0-1 years | −0.1 |
| | 10+ years | 0.06 |
| Star rating | star rating <4 | −0.05 |
| | star rating >=4 | 0.03 |
| Votes | votes >5 | 0.02 |
| Parking available | not or only paid | 0.05 |
| Job on same day | same day | 0.06 |
| Personnel profile picture | missing profile picture | −0.1 |

After weight coefficients are calculated for a job match, base rate may be fetched (from a database as described above) for a job zip code and license type combination of the job. If there is no data for the zip code license type combination of the job, a base rate may be fetched (from a database) for a license type and city combination instead. If there is no data for a job area, a default rate may be used from an application configuration. Once calculated a suggested rate may be stored in a job match table as a column of an appropriate job match.

As a non-limiting example, and still referring to FIG. 9, merit quantitative field 120 may include a fuzzy set. As a further non-limiting example, merit quantitative field 120 may include a bivalent set defined on an interval. Deriving merit quantitative field 120 may include, in a non-limiting example, providing a merit quantitative field machine-learning model 124 and deriving the merit quantitative field 120 as a function of the plurality of resource data 112 and the machine-learning model. Generating merit quantitative field 120 may include generating a biasing element 128 and generating the merit quantitative field 120 as a function of the biasing element 128, in a non-limiting example. Biasing element 128 may be tuned as a function of a plurality of distributed factors 132, for instance as described above in reference to FIGS. 1-5. In an embodiment, biasing element 128 may include a social rating, which may depend upon inputs from one or more users of system 100 concerning timeliness of arrival at jobs, including arrival with sufficient lead time, level of professionalism of dress, including for instance scrubs for medical professionals, good grooming, appropriate footwear, refraining from perfumes and/or colognes, or the like, professional comportment, particularly in front of clients, patients, or the like, clock management, appropriately limited cell phone use, appropriate interaction according to preferences of existing staff, and remembering to thank supervisors and/or other people at niche

At step 915, and with continued reference to FIG. 9, computing device 104 computes a niche model 140; this may be implemented, without limitation, as described above in reference to FIGS. 1-5. For instance, niche model 140 may include a plurality of niche data 144 and an output quantitative field 148. In a non-limiting example, output quantitative field 148 may include a fuzzy set. In a further non-limiting example, output quantitative field 148 may include a bivalent set defined on an interval. Niche data 144 may include, without limitation, location, such as an address or other, geographical location of one or more work sites for niche. Niche data 144 may include an identity of an institution, staffing company, or other entity at and/or to which resource may report when filling niche and/or performing tasks called for by niche. Niche data 144 may include identities of one or more persons who will be working with resource, including without limitation supervisors, teammates, people who will be reporting to resource, or the like. Niche data 144 may include equipment to be used during performance of tasks for niche. Niche data 144 may include computer programs to be operated for performance of niche. Niche data 144 may include hours to be worked for niche, including daily hours, weekly hours, a total number of hours, or the like, days on which work is to be performed, shifts to be covered, or other logistical matters. Niche data 144 may include a role to be filled, one or more tasks to be performed, license and/or certification requirements, a desired level of experience, or the like. Niche data 144 may include a number of people needed or permitted to be utilized for niche. Niche data 144 may include information about the nature and/or specifics of patients and/or clientele. Niche data 144 may include Information about hazards, allergens, or the like present at a worksite

At step 920, and still referring to FIG. 9, computing device 104 combines niche model 140 with at least a selected resource model 116 corresponding to a selected resource of plurality of resources; this may be implemented, without limitation, as described above in reference to FIGS. 1-5. Combining may include classifying output quantitative field 148 to at least a selected merit quantitative field 120 of at least a selected resource model 116. Combining may include classifying at least a niche datum of plurality of niche data 144 to at least a datum of plurality of resource data 112. Combining niche model 140 to at least a selected resource model 116 may include combining the niche model 140 to the at least a selected resource model 116 using a classifying machine-learning process 152. Combining niche model 140 with at least a selected resource model 116 may include combining the niche model 140 to a single resource model 116 corresponding to a single resource of plurality of resources. Combining niche model 140 to single resource model 116 may include defining a direct-match subset 156 of plurality of niche elements, classifying a set of resource data 112 of plurality of resource data 112 corresponding to the single resource model 116 to the direct-match subset 156, classifying merit quantitative field 120 of the single resource model 116 to output quantitative field 148, and combining the single resource model 116 to the niche model 140. As a non-limiting example, direct-match subset 156 may include output quantitative field 148, a cumulative social rating and/or rating by supervisors, former supervisors, current and/or former coworkers, or the like, and attendance records. In an embodiment, a match of direct-match subset 156 may result in an “auto hire” or “easy hire” process where professionals are instantly hired when they apply to a job post or other niche if they meet direct-match criteria; this process may be helpful for immediate temporary hiring situations, such as without limitation staff calling out sick with short notice, staff being called up or activated for military duty, sudden increases in work volume due to external events, or the like. Direct-match subset 156 may be used only for specific situations such as for “last minute” niches or jobs, including as a non-limiting example jobs posted within 24 hours of the scheduled start time.

At step 925, and with continued reference to FIG. 9, computing device 104 provides an indication of the at least a selected resource model 116 to a client device of the niche model 140; this may be implemented, without limitation, as described above in reference to FIGS. 1-5. Provision may be performed according to any process described above, including without limitation transmission of an email generated automatically or using a template. For instance, a template for an email for rehire of a resource to a niche may, as a non-limiting example, include the following:

“Hi *|officeName|*
To ensure accurate payroll, please approve the hours and pay for
*|fullNamePersonnel|* for the *|job Type|* job worked *|day|* at
*|fullJobAddress|* within the next *|leftTime|* (excluding Sunday.) If hours are
not approved within *|leftTime|*, we will automatically charge your office based
on the professional’s clocked in/out times, or the original scheduled hours if clock
information is missing. We will also factor in an hour break for job durations
lasting over 8 hours IF a break has not already been indicated.
Employee: * |fullNamePersonnel| *
Date: * |day|*
Job Type: * |jobType|*
Location: * |fullJob Address|*
Hours: * |hours|*
Pay: $*|amount|*
Collection Account #: XXXX *|paymentMethod|*
You will automatically be charged the above amount if you do not approve the
professional’s hours within *|leftTime| *. If you have to make any modifications,
you must do so within that timeframe.
Click to modify or approve hours
Would you like to work with *|fullNamePersonnel|* again?
Re-hire *|fullNamePersonnel|*
Please contact Support immediately if the email address that we have on file for
you is going to change in the near future. As always, please do not hesitate to
contact us with any questions. We’re here to help.
Sincerely,”

Where *|officeName|*, *|fullNamePersonnel|*, *|jobType|*, *|day|*, *|fullJobAddress|*, *|leftTime|*, *|hours|*, *|amount|*, and *|paymentMethod|* may represent fields to be automatically filled and/or replaced with niche data 144 and/or resource data 112 such as, respectively, a name of an office for niche, a full name of a resource, a job type to be performed, a day on which job is to commence and/or be performed, a full address of a worksite, time left before the job is to commence, hours to be worked during the job, a wage or other form of compensation, and a payment source such as a credit card, bank, or the like. Provision may alternatively or additionally be performed using one or more push notifications, text messages, or other protocols for electronic communication. Niche client device and/or a user thereof may enter and/or transmit a selection of a resource from at least a resource provided to Niche client device.

Still referring to FIG. 9, system 100 may perform continuing analysis and/or communication with and/or concerning an operator of niche, with resource, or with other persons. For instance, and without limitation, system 100 may track location of resource as a function of time. Tracking may include detecting that resource has logged onto a workstation and/or has “punched in” and/or “punched out” to determine that resource is located at a worksite corresponding to niche. Tracking may include one or more geolocation and/or geofence determinations, where an approximate or exact geographical location of resource at a given time may be determined. Geographical location may be determined, without limitation, using a device operated by resource and one or satellite-based navigation facilities such as the Global Positioning System (GPS), GLONASS, Galileo, BeiDou, QZSS, IRNSS and/or NavIC. Geographical location may alternatively or additionally be detected using cell tower triangulation, signal contact and/or signal strength from one or more beacons, Wi-Fi devices, or other wireless signal sources, or the like. In an embodiment, geographical tracking of resource enables system 100 to determine when resource is at a job site, how likely resource is to arrive on time, and/or when resource is likely to arrive, when resource has finished working, or the like.

Still referring to FIG. 9, in an embodiment, system 100 may track whether a resource has canceled and/or failed to show up for work associated with niche. System 100 may automatically inactivate availability of resource for matching and/or combination processes as described above upon a cancelation by resource that is within a threshold limit of time prior to scheduled commencement of work, such as 24 hours or the like, which may be referred to as a “late cancelation.” For instance, system 100 may temporarily suspend resource for a first such cancelation; two late cancelations may include removal of resource from system 100. As a further example resource may be inactivated if resource receives a rating and/or other distributed factor 132 from, for instance, a supervisor, which is below a threshold limit such as two stars in a five-star rating system or the like. In an embodiment, a first rating below a threshold limit may result in inactivation for a first period of time, while a second such rating within a given period of days may result in a second period of inactivation; second period may be longer than first period. As a non-limiting example, a resource receiving a first 2-star review or lower may be inactivated for 14 days, and receipt of a second within a period of 30 days may result in inactivation for 28 days. Where “strikes” are recorded based on performance and/or cancelation, system may remove one strike or all strikes after some period of time has passed, such as 90 days, without further incidents that would cause inactivation and/or banning.

With continued reference to FIG. 9, system 100 may automatically repost canceled jobs; that is, when a resource cancels a job at a niche to which resource has been classified, system 100 may repeat one or more processes and/or process steps to associate niche with another resource. System 100 may automatically repost a niche and/or reiterate upon completion of a time period in niche; that is, niche may be iteratively recreated and reposted. In an embodiment, a resource that has completed a first term of employment for niche may be automatically rematched to niche if one or more threshold conditions concerning resource and/or job performance by resource are satisfied. One or more threshold conditions may include, without limitation, a rating by one or more supervisors or coworkers above a certain level, or the like.

Still referring to FIG. 9, a system 100 may use characteristics of a previously matched and/or employed resource to find a resource for rehire and/or to replace previously matched resource. For instance, and without limitation, where a first resource was previously matched and/or employed, system 100 may classify a second resource to be matched to the first resource; second resource may then be hired. Alternatively, system 100 may use classification to select a second resource that is similar to first resource in some ways while different in others; for instance first resource may have a first set of characteristics that were optimal for the niche and a second set of resources that were not optimal for the niche. In an embodiment, a user such as a former supervisor and/or coworker may identify one more characteristics of first set of characteristics and/or second set of characteristics and enter such identification into system 100. In some embodiments, user may enter alternative values for second set of characteristics; second resource may be classified to first resource with second set replaced by user-entered characteristics. Alternatively or additionally, user may enter a degree of dissatisfaction with one or more characteristics in second set; system 100 may translate degree of dissatisfaction into a distance used in a clustering and/or classification algorithm as described above and may identify resources and/or cluster centroids having characteristics of second set that are that distance from characteristics of second set relating to first resource. Identified centroids may be presented to user and/or values thereof corresponding to second set may be substituted into a resource model of first resource to generate a plurality of candidate models. A classification algorithm as described above may then match a candidate model to niche model 140, and second resource may be identified by classification of resource models to matching candidate model. Alternatively or additionally, values of second set may be replaced by random values in each candidate model and/or values for each cluster centroid identified using clustering algorithm as described above may be used for candidate values; cluster centroid values may be randomly selected. In an embodiment, random generation of candidate values and classification may be performed iteratively until a match exceeding a given threshold measure of similarity is achieved. Any of these processes may also be performed iteratively for initial matching by beginning with randomly selected values for one or more resource models and iteratively regenerating and reclassifying until a match exceeding a threshold measure of similarity is achieved.

Still referring to FIG. 1, in some embodiments, GPU may implement a compatibility algorithm or generate a compatibility machine-learning module to determine a match score between a resource and a niche model 136. For the purposes of this disclosure, a “match score” is a measurable value representing the likelihood a resource will be able to match a given niche model 136. In one or more non-limiting embodiments, match score may be a quantitative characteristic, such as a numerical value within a set range. For example, a match score may be a “2” in a set range of 1-10, where “1” represents niche model 136 and the resource having a minimum compatibility and “10” represents niche model and the resource having a maximum compatibility. In other non-limiting embodiments, match score may be a quality characteristic, such as a color coding, where each color is associated with a level of compatibility. In one or more embodiments, if a match score is “low,” then a resource and niche model 136 are considered to have a minimum compatibility; if a match score is “high,” then a resource and the niche model 136 are considered to have a maximum compatibility.

For the purposes of this disclosure, a “compatibility algorithm” is an algorithm that determines the likelihood a resource will be successful in matching with a given niche model 136. Compatibility algorithm may include machine-learning processes that are used to calculate a set of match scores. Machine-learning process may be trained by using training data associated with past calculations and/or information for the job position and user, such as data related to past match scores, resource data112, niche data 144, or any other training data described in this disclosure. Match score may be determined by, for example, if a certain numerical value of employment position data matches user data, where the more employment position data that matches user data, the higher the score and the greater the compatibility between the user and the job position. For example, and without limitation, niche model 136 may include a qualification of requiring a teacher with at least five years of work experience and a posting wage index of a yearly salary of $40,000-$60,000, and resource model 116 may include seven years of work experience in teaching and candidate wage index of $50,000-$70,000, then a numerical value representing match score may be increased due to the data correlating, thus indicating user is more compatible for the posting. In an embodiment, compatibility algorithm may be received from a remote device. In some embodiments, compatibility algorithm is generated by GPU. In one or more embodiments, compatibility algorithm may be generated as a function of a resource input.

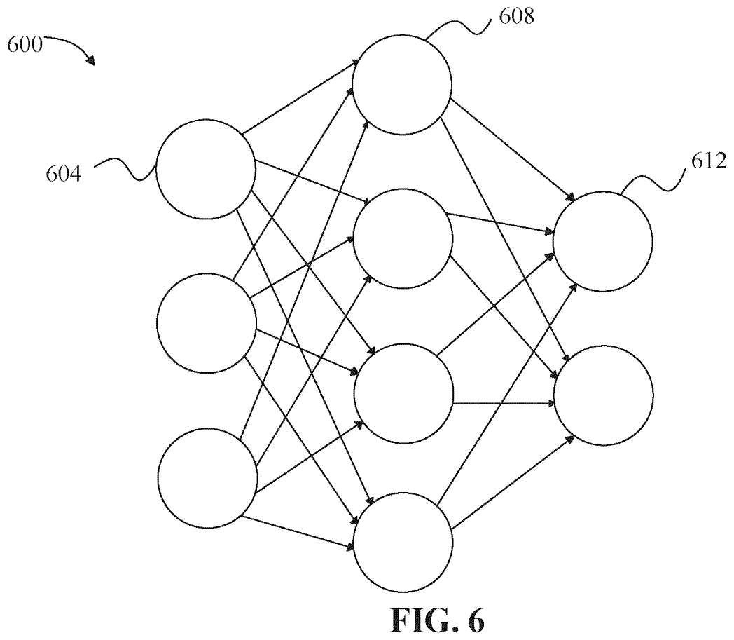

Referring not to FIG. 6, an exemplary embodiment of neural network 600 is illustrated. A neural network 600 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 604, one or more intermediate layers 608, and an output layer of nodes 612. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

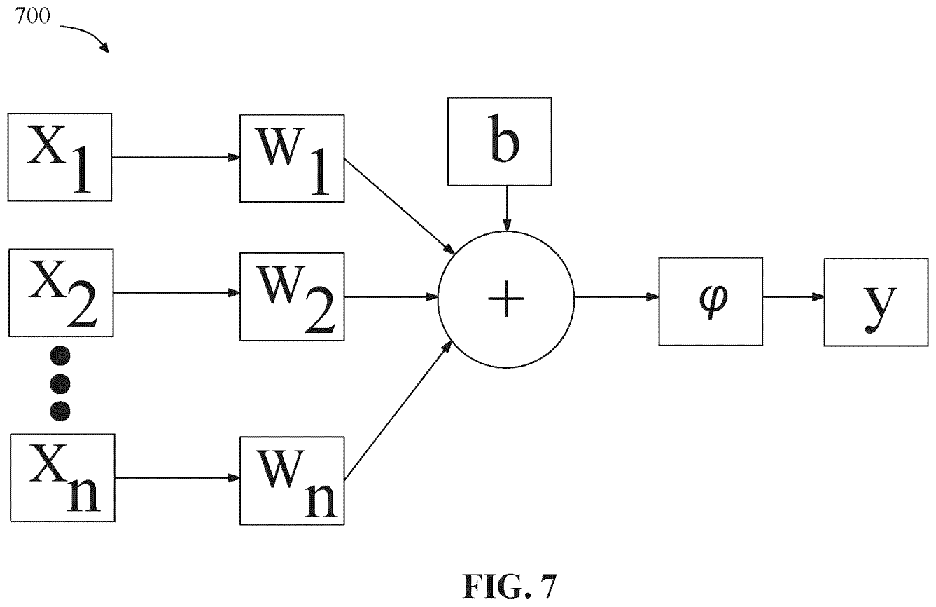

Referring now to FIG. 7, an exemplary embodiment of a node 700 of a neural network is illustrated. A node may include, without limitation, a plurality of inputs xi that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max(0, x), a “leaky” and/or “parametric” rectified linear unit function such as f(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of a (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

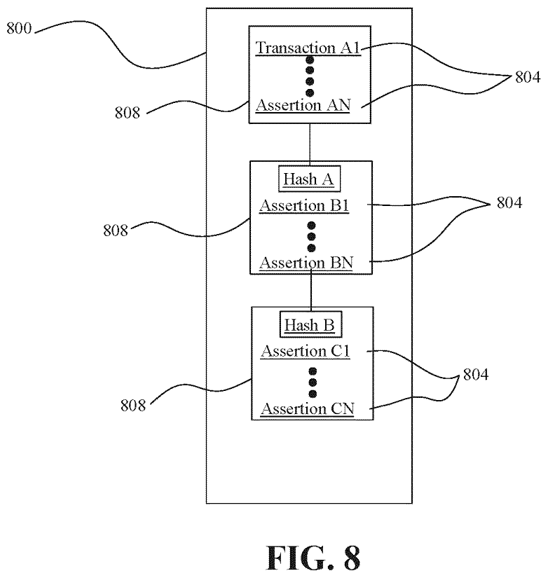

Referring now to FIG. 8, An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

Referring now to FIG. 8, an exemplary embodiment of an immutable sequential listing 800 is illustrated. Data elements are listed in immutable sequential listing 800; data elements may include any form of data, including textual data, image data, encrypted data, cryptographically hashed data, and the like. Data elements may include, without limitation, one or more at least a digitally signed assertions. In one embodiment, a digitally signed assertion 804 is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion 804. In an embodiment, collection of textual data states that the owner of a certain transferable item represented in a digitally signed assertion 804 register is transferring that item to the owner of an address. A digitally signed assertion 804 may be signed by a digital signature created using the private key associated with the owner's public key, as described above.

Still referring to FIG. 8, a digitally signed assertion 804 may describe a transfer of virtual currency, such as crypto-currency as described below. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g., a ride share vehicle or any other asset. A digitally signed assertion 804 may describe the transfer of a physical good; for instance, a digitally signed assertion 804 may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion 804 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 8, in one embodiment, an address is a textual datum identifying the recipient of virtual currency or another item of value in a digitally signed assertion 804. In some embodiments, address is linked to a public key, the corresponding private key of which is owned by the recipient of a digitally signed assertion 804. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion 804 may record a subsequent a digitally signed assertion 804 transferring some or all of the value transferred in the first a digitally signed assertion 804 to a new address in the same manner. A digitally signed assertion 804 may contain textual information that is not a transfer of some item of value in addition to, or as an alternative to, such a transfer. For instance, as described in further detail below, a digitally signed assertion 804 may indicate a confidence level associated with a distributed storage node as described in further detail below.

In an embodiment, and still referring to FIG. 8 immutable sequential listing 800 records a series of at least a posted content in a way that preserves the order in which the at least a posted content took place. Temporally sequential listing may be accessible at any of various security settings; for instance, and without limitation, temporally sequential listing may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing 800 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 8, immutable sequential listing 800 may preserve the order in which the at least a posted content took place by listing them in chronological order; alternatively or additionally, immutable sequential listing 800 may organize digitally signed assertions 804 into sub-listings 808 such as “blocks” in a blockchain, which may be themselves collected in a temporally sequential order; digitally signed assertions 804 within a sub-listing 808 may or may not be temporally sequential. The ledger may preserve the order in which at least a posted content took place by listing them in sub-listings 808 and placing the sub-listings 808 in chronological order. The immutable sequential listing 800 may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger, but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing 800 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 8, immutable sequential listing 800, once formed, may be inalterable by any party, no matter what access rights that party possesses. For instance, immutable sequential listing 800 may include a hash chain, in which data is added during a successive hashing process to ensure non-repudiation. Immutable sequential listing 800 may include a block chain. In one embodiment, a block chain is immutable sequential listing 800 that records one or more new at least a posted content in a data item known as a sub-listing 808 or “block.” An example of a block chain is the BITCOIN block chain used to record BITCOIN transactions and values. Sub-listings 808 may be created in a way that places the sub-listings 808 in chronological order and link each sub-listing 808 to a previous sub-listing 808 in the chronological order so that any computing device may traverse the sub-listings 808 in reverse chronological order to verify any at least a posted content listed in the block chain. Each new sub-listing 808 may be required to contain a cryptographic hash describing the previous sub-listing 808. In some embodiments, the block chain contains a single first sub-listing 808 sometimes known as a “genesis block.”

Still referring to FIG. 8, the creation of a new sub-listing 808 may be computationally expensive; for instance, the creation of a new sub-listing 808 may be designed by a “proof of work” protocol accepted by all participants in forming the immutable sequential listing 800 to take a powerful set of computing devices a certain period of time to produce. Where one sub-listing 808 takes less time for a given set of computing devices to produce the sub-listing 808 protocol may adjust the algorithm to produce the next sub-listing 808 so that it will require more steps; where one sub-listing 808 takes more time for a given set of computing devices to produce the sub-listing 808 protocol may adjust the algorithm to produce the next sub-listing 808 so that it will require fewer steps. As an example, protocol may require a new sub-listing 808 to contain a cryptographic hash describing its contents; the cryptographic hash may be required to satisfy a mathematical condition, achieved by having the sub-listing 808 contain a number, called a nonce, whose value is determined after the fact by the discovery of the hash that satisfies the mathematical condition. Continuing the example, the protocol may be able to adjust the mathematical condition so that the discovery of the hash describing a sub-listing 808 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 808 according to the protocol is known as “mining.” The creation of a new sub-listing 808 may be designed by a “proof of stake” protocol as will be apparent to those skilled in the art upon reviewing the entirety of this disclosure.

Continuing to refer to FIG. 8, in some embodiments, protocol also creates an incentive to mine new sub-listings 808. The incentive may be financial; for instance, successfully mining a new sub-listing 808 may result in the person or entity that mines the sub-listing 808 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 808 Each sub-listing 808 created in immutable sequential listing 800 may contain a record or at least a posted content describing one or more addresses that receive an incentive, such as virtual currency, as the result of successfully mining the sub-listing 808.

With continued reference to FIG. 8, where two entities simultaneously create new sub-listings 808, immutable sequential listing 800 may develop a fork; protocol may determine which of the two alternate branches in the fork is the valid new portion of the immutable sequential listing 800 by evaluating, after a certain amount of time has passed, which branch is longer. “Length” may be measured according to the number of sub-listings 808 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 808 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing 800 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing 800.

Still referring to FIG. 8, additional data linked to at least a posted content may be incorporated in sub-listings 808 in the immutable sequential listing 800; for instance, data may be incorporated in one or more fields recognized by block chain protocols that permit a person or computer forming a at least a posted content to insert additional data in the immutable sequential listing 800. In some embodiments, additional data is incorporated in an unspendable at least a posted content field. For instance, the data may be incorporated in an OP_RETURN within the BITCOIN block chain. In other embodiments, additional data is incorporated in one signature of a multi-signature at least a posted content. In an embodiment, a multi-signature at least a posted content is at least a posted content to two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto-currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. the latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 8, in some embodiments, virtual currency is traded as a crypto-currency. In one embodiment, a crypto-currency is a digital, currency such as Bitcoins, Peercoins, Namecoins, and Litecoins. Crypto-currency may be a clone of another crypto-currency. The crypto-currency may be an “alt-coin.” Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular entity. For instance, crypto-currency may be maintained in a centralized ledger, as in the case of the XRP currency of Ripple Labs, Inc., of San Francisco, Calif. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings X08 in a block chain computationally challenging; the incentive for producing sub-listings X08 may include the grant of new crypto-currency to the miners. Quantities of crypto-currency may be exchanged using at least a posted content as described above.

Referring now to FIG. 9, an exemplary embodiment of a method 900 of classifying resource models to niche models is illustrated. At step 905, at least a processor generates a niche model, wherein the niche model comprises a plurality of niche data, without limitation, as described above in reference to FIGS. 1-8.

At step 910, the at least a processor generates, using a credential classifier, an attribute match datum, wherein the credential classifier is configured to receive a credential datum from a resource, classify, using a credential classifier, the credential datum into the attribute match datum as a function of a plurality of required credentials. Without limitation, as described above in reference to FIGS. 1-8.

At step 915, the at least a processor matches the niche model to a resource model as a function of the attribute match datum, without limitation, as described above in reference to FIGS. 1-8.

At step 920, at least a processor provides an indication of the matched resource model to a client device associated with the niche model, wherein providing the indication further comprises automatically selecting a single resource, and automatically informing the single resource as a function of the client device, without limitation, as described above in reference to FIGS. 1-8.

Computing device may further be configured to track the arrival of a resource at a place of work using an attendance confirmation datum, Additionally, the computing device may further be configured to generate the attendance confirmation datum using at least a digital signature. The computing device may be configured to generate the attendance confirmation datum using at least a resource identification device. A resource's time sheet may also be verified as function of a time sheet verification datum using a computing device. The computing device may further be configured to monitor the niche model after the combination of the niche model with at least a selected resource model using a by-pass engine. Furthermore, the computing device may place the niche model in the banning protocol as a function of being flagged by the bypass engine. The computing device may also receive a plurality of resource data corresponding to a plurality of resources. The computing device may additionally be configured to further generate a plurality of resource models, The computing device may also generate a plurality of resource models further comprises generating a biasing element.

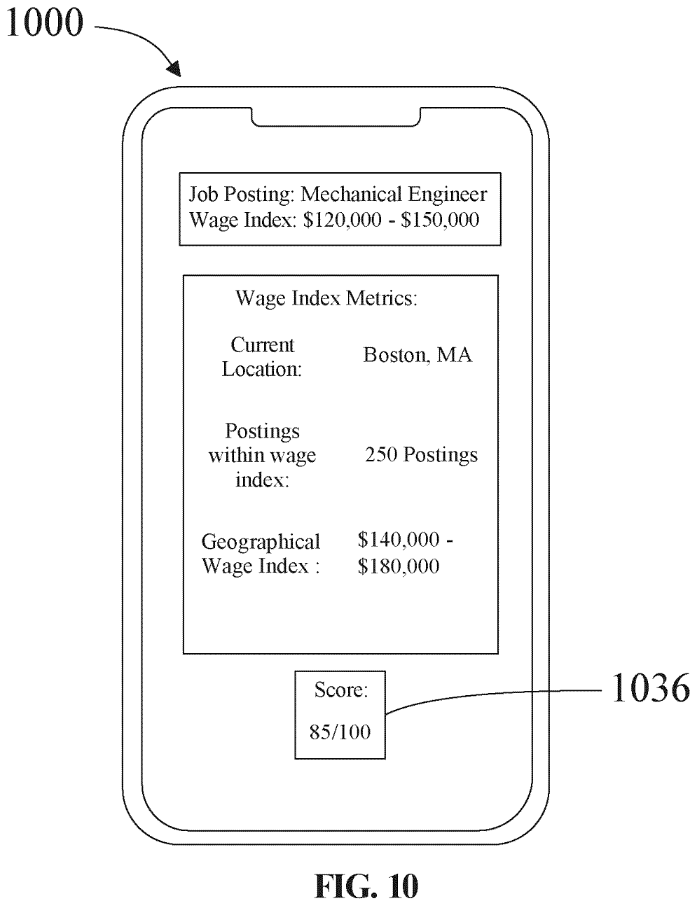

Now referring to FIG. 10, a diagrammatic representation of an exemplary embodiment of a display device. Display device may be communicatively connected to the processor. In some embodiments, processor may be configured to display Wage Index match datum and/or Wage compatibility score 1036 on display device. Wage Index match datum may include any of the aforementioned metrics. In other embodiments, display device may be configured to display score 1036 calculated. In some embodiments, display device may be configured to display a color code for the score 1036. A “color code,” as used in this disclosure, is any color that displays score 1036 in terms of cost-efficiency.

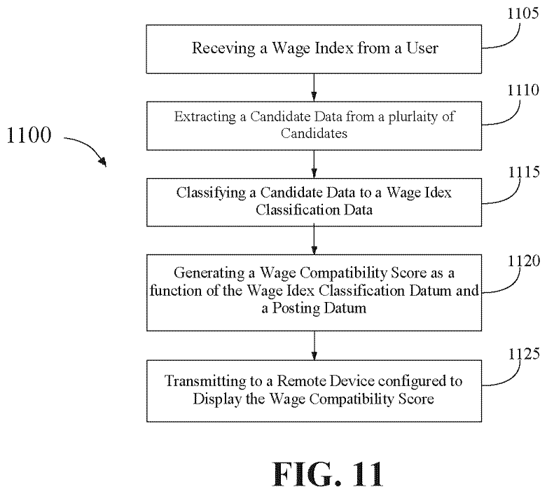

Referring now to FIG. 11, an exemplary method 1100 of wage index classification is illustrated. At step 1105, a processor receives a wage index from a user, this may be implemented, without limitation, as described above in reference to FIGS. 1-7.

At step 1110, a processor extracts a candidate data from a plurality of candidates; this may be implemented, without limitation, as described above in reference to FIGS. 1-7.

At step 1115, a processor classifies a candidate data to a wage index classification data; this may be implemented, without limitation, as described above in reference to FIGS. 1-7.

At step 1120, a processor generates a wage compatibility score as a function of wage index classification datum and a posting datum; this may be implemented, without limitation, as described above in reference to FIGS. 1-10.

At step 1125, a processor transmits to a display device to configured to display the wage compatibility score, this may be implemented, without limitation, as described above in reference to FIGS. 1-7.

Further referring to FIG. 11, a processor may further be configured to classify the posting datum to the wage index classification data using a wage index classifier. A wage compatibility score may be generated using a wage index machine learning model. A wage index may include a summation of all financial compensation given to a candidate. A wage index may also include a geographical wage index. A processor can be configured to generate a candidate wage index and/or a posting wage index. A processor may further be configured to store wage index classification datum in a wage index database. A processor may further be configured to classify candidates as a function of the posting. A processor may further be configured to classify posting data to wage index classification data.

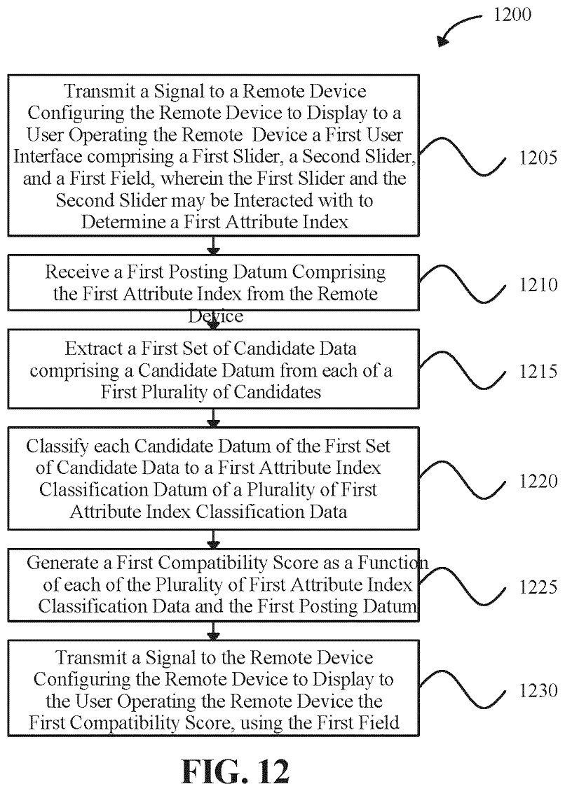

Referring now to FIG. 12, an exemplary embodiment of a method 1200 of attribute index classification is illustrated. One or more steps if method 1200 may be implemented, without limitation, as described with reference to other figures. One or more steps of method 1200 may be implemented, without limitation, using at least a processor.

Still referring to FIG. 12, in some embodiments, method 1200 may include transmitting a signal to a remote device configuring the remote device to display to a user operating the remote device a first user interface comprising a first graduated data entry field, a second graduated data entry field, and a first field, wherein the first graduated data entry field and the second graduated data entry field may be interacted with to determine a first attribute index 1205. In some embodiments, the first user interface further includes a fourth field and a fifth field, wherein the fourth field is associated with the first graduated data entry field, wherein the first user interface is configured such that a user input into the fourth field changes the position of the first graduated data entry field, wherein the fifth field is associated with the second graduated data entry field, wherein a user input into the fifth field changes the position of the second graduated data entry field. In some embodiments, the first graduated data entry field and the second graduated data entry field each comprise default positions determined as a function of the first set of candidate data.

Still referring to FIG. 12, in some embodiments, method 1200 may include receiving a first posting datum comprising the first attribute index from the remote device 1210. In some embodiments, the first attribute index comprises a wage index. In some embodiments, the first attribute index comprises an employment start date index. In some embodiments, the first attribute index comprises a work from home availability index.

Still referring to FIG. 12, in some embodiments, method 1200 may include extracting a first set of candidate data comprising a candidate datum from each of a first plurality of candidates 1215.

Still referring to FIG. 12, in some embodiments, method 1200 may include classifying each candidate datum of the first set of candidate data to a first attribute index classification datum of a plurality of first attribute index classification data 1220. In some embodiments, classifying each candidate datum of the first set of candidate data includes training an attribute index classifier using first training data, wherein the first training data contains a plurality of data entries correlating candidate data elements as inputs to attribute index classification data elements as outputs; and classifying each candidate datum of the first set of candidate data to its respective attribute index classification datum using the attribute index classifier.

Still referring to FIG. 12, in some embodiments, method 1200 may include generating a first compatibility score as a function of each of the plurality of first attribute index classification data and the first posting datum 1225. In some embodiments, generating the first compatibility score includes training an attribute index machine learning model using second training data, wherein the second training data contains a plurality of data entries correlating attribute index classification data elements and posting data elements as inputs to first compatibility score elements as outputs; and generating, using the trained attribute index machine learning model, the first compatibility score for each first attribute index classification datum of the plurality of first attribute index classification data, wherein each attribute index classification datum of the plurality of first attribute index classification data and the posting datum are provided to the trained attribute index machine learning model as an input to output the first compatibility score; and numerically correlating the first plurality of candidates and the posting datum as a function of the first compatibility score.

Still referring to FIG. 12, in some embodiments, method 1200 may include transmitting a signal to the remote device configuring the remote device to display to the user operating the remote device the first compatibility score, using the first field 1230.

Still referring to FIG. 12, in some embodiments, method 1200 may further include transmitting a signal to a remote device configuring the remote device to display to a user operating the remote device a second user interface comprising a third graduated data entry field, a fourth graduated data entry field, and a second field, wherein the third graduated data entry field and the fourth graduated data entry field may be interacted with to determine a second attribute index; receiving a second posting datum including the second attribute index from the remote device; extracting a second set of candidate data comprising a candidate datum from each of a second plurality of candidates; classifying each candidate datum of the second plurality of candidates to a second attribute index classification datum; generating a second compatibility score as a function of the second attribute index classification datum and the second posting datum; and transmitting a signal to the remote device configuring the remote device to display to the user operating the remote device the second compatibility score, using the second field.

Still referring to FIG. 12, in some embodiments, method 1200 may further include generating a third compatibility score as a function of the first attribute index classification datum, the second attribute index classification datum, the first posting datum, and the second posting datum, wherein the third compatibility score represents compatibility across a plurality of attributes; and transmitting a signal to the remote device configuring the remote device to display to the user operating the remote device the third compatibility score, using a third field.

With continued reference to FIG. 12, in some embodiments processor may automatically publish postings when an attribute compatibility score is within a predetermined threshold. Posting datum may be posted on any job board and/or job aggregator website specified by an employer. Without limitation, if attribute score of an attribute index such as a wage index is between a 6 and 10 (using the scoring system in a previous example), then processor may publish said posting. As used in this disclosure, a “predetermined threshold” is a limit and/or range of an acceptable quantitative value and/or combination of values such as an n-tuple or function such as linear function of values, and/or representation related to the scoring of a posting. Predetermined threshold may be determined by an employer or user of apparatus 100. Additionally or alternatively, predetermined threshold may be determined by processor using machine learning module 300.

With continued reference to FIG. 12, predictive scoring metric is displayed to the employer. Predictive scoring metric is displayed using a graphic user interface (GUI). Alternatively or additionally, score may be displayed using a GUI. GUI may include a plurality of lines, images, symbols, etc. as illustrated in FIG. 10. GUI may be displayed on a display device. Display device may include, but is not limited to, a smartphone, tablet, laptop, monitor, tablet, and the like. Display device may include a separate device that includes a transparent screen configured to display computer generated images and/or information. The employer may view the information displayed on the display device in real time.

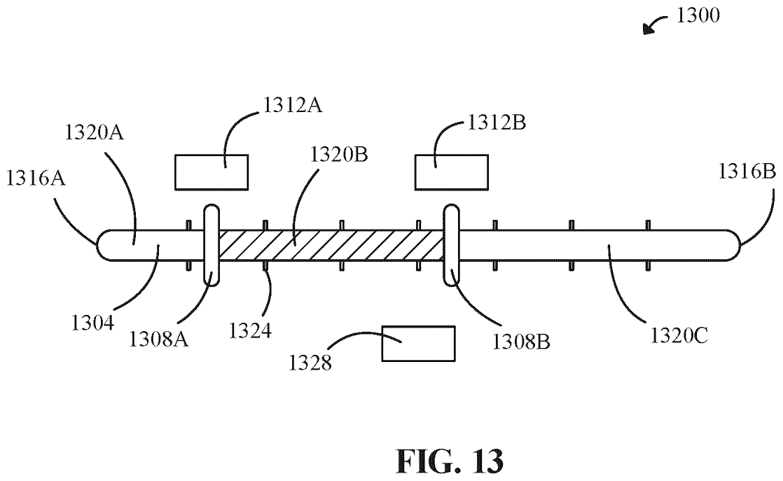

Referring now to FIG. 13, an exemplary user interface (UI) 1300 is depicted. UI 1300 may include a bar 1304 or other display area that includes one or more graduated data entry fields 1308A and 1308B. A “graduated data entry field,” as used in this disclosure, is a field in which a user may select along a range of values from a minimum to a maximum value. Minimum and maximum values may be fixed or may themselves be variable by user selection, either explicitly by entering or selecting such values or implicitly by moving, e.g., a slider or other element of such a field toward a minimum or maximum value, which may trigger such a value to increase and/or decrease. A graduated data entry field may include a “continuous data entry field,” which is one where a user can enter any of an apparently continuous range of values, which may include a slider, an image of a lever, a virtual dial or the like; values from a continuous data entry field may be stored in floating point format and/or as integer values. Alternatively or additionally, a graduated data entry field may include “quantized data entry field” including a plurality of quantized values that a user may select with using, e.g. buttons or any visual element suitable for use as a continuous data entry field, in which movement though a range of motion may trigger repeated increments of such quantized values. A Bar 1304 may represent an axis along which sliders 1308A and 1308B may move; about which other graduated data entry field elements may rotate, or the like; Bar 1304 may represent a range of possible values for graduated data entry field. Bar 1304 may represent, in non-limiting examples, wage, time availability, and commute time. Time availability may include desired start dates, such as ranges from a first calendar date to a second calendar date or ranges relative to a date such as the current date. Time availability may include schedule availability once a job is started, such as which times of day a candidate is available, which days of the week a candidate is available and/or which holidays a candidate would want to have off. Slider or other graduated data entry field 1308A may represent a minimum, such as a minimum wage, an earliest start date, and the like. Slider or other graduated data entry field 1308B may represent a maximum, such as a maximum wage, a latest start date, and the like. Sliders 1308A and/or 1308B may be interactable. For example, a user may move slider or other graduated data entry field 1308A along bar 1304 in order to change a minimum. Similarly, a user may move slider or other graduated data entry field 1308B along bar 1304 in order to change a maximum. In some embodiments, bar 1304 may include visuals indicating a distribution of candidates or employers across the relevant attribute. For example, a section of bar 1304 which has overlap with a high number of candidate ranges may be green, and a section of bar 1304 which has low overlap may be red.

Still referring to FIG. 13, UI 1300 may also include fields 1312A and/or 1312B. Field 1312A may depict the value of slider or other graduated data entry field 1308A and field 1312B may depict the value of slider 1312B. Fields 1312A and 1312B may be interactable. For example, a user may select field 1312A and type a value into it, and this may cause slider or other graduated data entry field 1308A to move to the appropriate location. Similarly, a user may select field 1312B and type a value into it, and this may cause slider or other graduated data entry field 1308B to move to the appropriate location.

Still referring to FIG. 13, UI 1300 may include first end 1316A and/or second end 1316B. In some embodiments, sliders 1308A and 1308B may not move beyond first end 1316A and/or second end 1316B. In some embodiments, first end 1316A and/or second end 1316B may extend in response to user input. For example, if a user drags slider or other graduated data entry field 1308A to, or close to, first end 1316A, then first end 1316A may move, extending bar 1304 and allowing for more room to move slider or other graduated data entry field 1308A. In another example, if a user drags slider or other graduated data entry field 1308A to, or close to, first end 1316A, then a scale of bar 1304 may change. For example, if bar 1304 initially represented a wage range from $50,000 to $130,000, and a user drags slider or other graduated data entry field 1308B to, or close to, end 1316B, then a scale of bar 1304 and/or a positioning of sliders 1308A and/or 1308B may change such that the wage range represented by bar 1304 is now $50,000 to $125,000.

Still referring to FIG. 13, UI 1300 may also include first region 1320A, second region 1320B, and/or third region 1320C. First region 1320A may include the values less than the value of slider or other graduated data entry field 1308A. Second region 1320B may include the values between the value of slider or other graduated data entry field 1308A and slider or other graduated data entry field 1308B. Third region 1320C may include the values higher than the value of slider or other graduated data entry field 1308B. UI 1300 may also include tick marks, such as tick mark 1324. Tick marks may indicate a scale of bar 1304.

Still referring to FIG. 13, UI 1300 may also include field 1328. Field 1328 may indicate a level of compatibility between attribute values determined by sliders 1308A and 1308B and/or fields 1312A and 1312B. Levels of compatibility may be determined as described herein with reference to other figures. In a non-limiting example, a level of compatibility may be determined as described above for the determination of an attribute compatibility score. Field 1328 may use a variety of methods to indicate a level of compatibility. In non-limiting examples, this may include percentage rankings (such as a percent of relevant candidates that have overlap with second region 1320B), color coding (such as green when there is high compatibility), images of faces displaying emotions (such as a smiling face when there is high compatibility), and the like. In some embodiments, field 1328 may be used to display a warning when a user inputs values that have low compatibility. For example, field 1328 may ordinarily be invisible, but may become visible and display a warning when a user drags sliders 1308A and/or 1308B to values that have low compatibility, such as a narrow range on one extreme of bar 1304.

Still referring to FIG. 13, in some embodiments, sliders 1308A and 1308B may include default positions and/or ends 1316A and 1316B may include default values. In some embodiments, default values and/or positions may be determined based on levels of compatibility. In a non-limiting example, if bar 1304 represents time before start of employment, then default positions of sliders 1308A and 1308B for an employer may be determined such that the middle 50% of relevant employees is within second region 1320B at default slider positions. In non-limiting examples, default positions may be determined such that there is any amount of overlap with a counterpart range, such that a counterpart range is completely encompassed, such that the center of a counterpart range is within a default range, such that there is a minimum compatibility score with default positions, and the like.

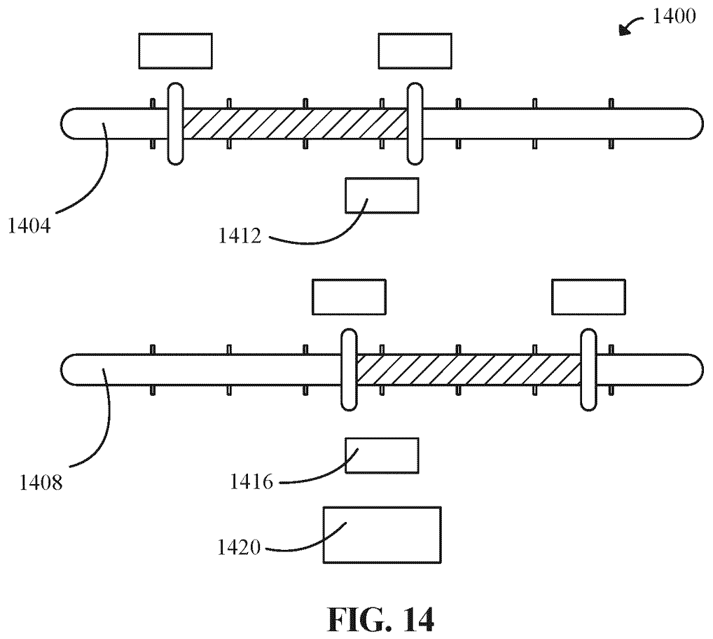

Referring now to FIG. 14, an exemplary UI 1400 is depicted. UI 1400 may include a first UI element 1404 and a second UI element 1408. Each UI element may include one or more UI components described with reference to FIG. 10. Each UI element may aid in determining compatibility for a different attribute. In a non-limiting example, first UI element 1404 may describe desired wage, and second UI element 1408 may describe desired start date. In some embodiments, more than 2 such UI elements may be present. In non-limiting examples, 2, 3, 4, 5, 6, 7, 8. 9, 10, or more such UI elements may be present. In a non-limiting example, users may be able to select attributes which are important to them and UI elements describing those attributes may appear.

Still referring to FIG. 14, field 1412 may indicate a level of compatibility based on the settings of UI element 1404, and field 1416 may indicate a level of compatibility based on the settings of UI element 1408. Additional fields may be present depending on how many UI elements are present. UI 1400 may also include field 1420. Field 1420 may describe an overall level of compatibility, based on the settings of all UI elements. Fields 1412, 1416, and 1420 may include visuals as described in the context of field 1028 with reference to FIG. 10. Including multiple such fields may aid users in determining which attributes they may need to adjust in order to achieve higher compatibility.

Now referring to FIGS. 13 and 14, in some embodiments, an apparatus may display to a user UI 1300, UI 1400, and/or one or more components thereof. In some embodiments, an apparatus may transmit a signal to a remote device operated by a user configuring the remote device to display to a user UI 1300, UI 1400, and/or one or more components thereof.

It is to be noted that any one or more of the aspects and embodiments described herein may be conveniently implemented using one or more machines (e.g., one or more computing devices that are utilized as a user computing device 104 for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

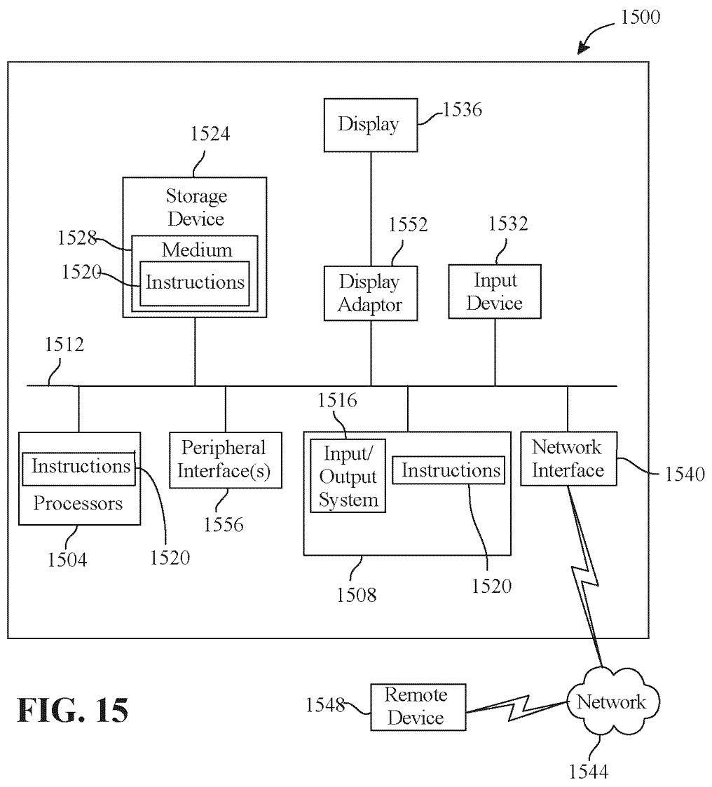

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Processor 1504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1504 may be organized according to Von Neumann and/or Harvard architecture as a non-limiting example. Processor 1504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. Display adapter 1552 and display device 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A system for monitoring a niche model using a by-pass engine, the system comprising:
at least a computing device, wherein the computing device comprises:
a memory; and
at least a processor communicatively connected to the memory, wherein the memory contains instructions configuring the at least a processor to:
generate a niche model, wherein the niche model comprises a plurality of niche data;
generate, using a credential classifier, an attribute match datum, wherein the credential classifier is configured to:
receive a credential datum from a resource,
classify, using the credential classifier, the credential datum into the attribute match datum as a function of a plurality of required credentials;
match the niche model to a resource model as a function of the attribute match datum; and
provide an indication of the matched resource model to a client device associated with the niche model, wherein providing the indication further comprises:
automatically selecting a single resource; and
automatically informing the single resource as a function of the client device.

2. The system of claim 1, wherein matching the niche model to the resource model as a function of a predefined threshold and the attribute match datum.

3. The system of claim 1, wherein matching the niche model to a resource model further comprises:
generating an attribute score for each of the resource model and the niche model, wherein the attribute score is associated with the attribute match datum;
aggregating a plurality of attribute scores; and
selecting a single resource based on a highest rank of the plurality of attribute scores.

4. The system of claim 1, wherein the system is further configured to connect with an external database using an application programming interface to iteratively generate an updated credential datum.

5. The system of claim 4, wherein the memory further instructs the processor to generate a secure timestamp associated with the updated credential datum, wherein the secure timestamp comprises a current time in a hash chain.

6. The system of claim 1, wherein the computing device is further configured to monitor the niche model after selecting a single resource using a by-pass engine.

7. The system of claim 6, wherein the computing device is further configured to place the niche model in a banning protocol as a function of being flagged by the by-pass engine.

8. The system of claim 7, wherein the system is configured to place the single resource in the banning protocol, wherein the banning protocol comprises:
placing the single resource through a confirmation process as a function of the indication of the matched resource model; and
preventing the single resource from being combined with additional niche models as a function of the confirmation process.

9. The system of claim 1, wherein the computing device is further configured to receive a plurality of resource data corresponding to a plurality of resources.

10. The system of claim 1, wherein the memory further instructs the processor to generate a geographical wage index as a function of the attribute match datum.

11. A method for classifying resources to niche models, wherein the method comprises:
generating, using at least a processor, a niche model, wherein the niche model comprises a plurality of niche data;
generating, using a credential classifier, an attribute match datum, wherein the credential classifier is configured to:
receive a credential datum from a resource,
classify, using a trained attribute classifier, the credential datum into the attribute match datum as a function of a plurality of required credentials;
matching, using the at least a processor, the niche model to a resource model as a function of the attribute match datum; and
providing, using the at least a processor, an indication of the matched resource model to a client device associated with the niche model, wherein providing the indication further comprises:
automatically selecting a single resource; and
automatically informing the single resource as a function of the client device.

12. The method of claim 11, wherein matching the niche model to the resource model as a function of a predefined threshold and the attribute match datum.

13. The method of claim 11, wherein matching the niche model to a resource model further comprises:
generating an attribute score for each of the resource model and the niche model, wherein the attribute score is associated with the attribute match datum;
aggregating a plurality of attribute scores; and
selecting a single resource based on a highest rank of the plurality of attribute scores.

14. The method of claim 11, connects with an external database using an application programming interface to iteratively generate an updated credential datum.

15. The method of claim 14, wherein generating a secure timestamp is associated with the updated credential datum, wherein the secure timestamp comprises a current time in a hash chain.

16. The method of claim 11, monitors the niche model after selecting a single resource using a by-pass engine.

17. The method of claim 16, wherein placing the niche model in a banning protocol as a function of being flagged by the by-pass engine.

18. The method of claim 17, wherein the banning protocol comprises:
placing the single resource through a confirmation process as a function of the indication of the matched resource model; and
preventing the single resource from being combined with additional niche models as a function of the confirmation process.

19. The method of claim 11, wherein receiving a plurality of resource data corresponds to a plurality of resources.

20. The method of claim 11, generates a geographical wage index as a function of the attribute match datum.
